(19) United States
(12) Patent Application Publication
(10) Pub. No.: US 2013/0179245 A1
(43) Pub. Date: Jul. 11, 2013

(54) System and Method for Providing Incentives to Users for Using Payment Instruments to Complete Financial Transactions

(71) Applicant: Jerome Simonoff, Marina del Rey, CA (US)

(72) Inventor: Jerome Simonoff, Marina del Rey, CA (US)

(21) Appl. No.: 13/736,877

(22) Filed: Jan. 8, 2013

Related U.S. Application Data
(60) Provisional application No. 61/584,769, filed on Jan. 9, 2012.

(51) Int. Cl. G06Q 30/02

(52) U.S. Cl. CPC G06Q 30/0222
USPC 705/14.23

(57) ABSTRACT

A system, computer-readable storage medium storing at least one program, and a computer-implemented method for providing incentives to users for using payment instruments to complete financial transactions is presented. Information identifying a user and a merchant is received from a device. A set of payment instruments that are available to the user and that are associated with incentives to be provided by the merchant are identified, where a respective payment instrument in the set of the payment instruments being associated with at least one incentive to be provided by the merchant when the user uses the respective payment instrument to fulfill a financial transaction with the merchant. Information identifying at least a subset of the set of payment instruments and the corresponding incentives is transmitted to the device.

### RELATED APPLICATIONS

This application claims priority to U.S. Provisional Patent Application No. 61/584,769, “System and Method for Providing Incentives to Users for Using Payment Instruments to Complete Financial Transactions,” filed Jan. 9, 2012, which is hereby incorporated by reference in its entirety.

### TECHNICAL FIELD

The disclosed embodiments relate generally to providing incentives to users for using payment instruments to complete financial transactions.

### BACKGROUND

A user may have an option to use one of a number of payment instruments to complete a financial transaction with a merchant. For example, the user may choose to complete the financial transaction with the merchant using cash, a debit card, or a credit card. The merchant may prefer some payment instruments over other payment instruments. For example, the merchant may prefer a debit card over a credit card because the transaction fees for the debit card may be lower than the credit card. Similarly, the merchant may prefer cash over a debit card or a credit card because cash may not be associated with any transaction fees. Furthermore, since some credit cards have higher merchant fees than other credit cards, the merchant may prefer one credit card over another credit card that has higher merchant fees.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings.

FIG. 1 is a block diagram illustrating a network system, according to some embodiments.

FIG. 2 is a block diagram illustrating a data structure for storing information for payment instruments that are accepted by a merchant, according to some embodiments.

FIG. 3 is a block diagram illustrating a data structure for storing information for payment instruments available to a user, according to some embodiments.

FIG. 4A is a block diagram illustrating a process for identifying payment instruments and associated incentives, according to some embodiments.

FIG. 4B continues the process illustrated in FIG. 4A, according to some embodiments.

FIG. 5A is a block diagram illustrating a process for identifying alternative payment instruments and associated incentives, according to some embodiments.

FIG. 5B continues the process illustrated in FIG. 5A, according to some embodiments.

FIG. 6 is a block diagram illustrating a process for storing information for payment instruments that are accepted by a merchant, according to some embodiments.

FIG. 7 is a block diagram illustrating a process for storing information for payment instruments that are available to a user, according to some embodiments.

FIG. 8 is a block diagram illustrating a server, according to some embodiments.

FIG. 9 is a block diagram illustrating a device, according to some embodiments.

FIG. 10 is a block diagram illustrating a payment processor server, according to some embodiments.

FIG. 11 is a block diagram illustrating a financial institution server, according to some embodiments.

FIG. 12 is a flowchart of a method for providing incentives to users for using payment instruments to complete financial transactions, according to some embodiments.

FIG. 13 is a flowchart of a method for identifying a set of payment instruments that are available to a user and that are associated with incentives to be provided by the merchant, according to some embodiments.

FIG. 14 is a flowchart of a method for determining a cost incurred by a merchant when a respective payment instrument is used by a user to complete a financial transaction with the merchant, according to some embodiments.

FIG. 15 is a flowchart of a method for storing information identifying a payment instrument that is available to a user, according to some embodiments.

FIG. 16 is a flowchart of a method for storing information for a payment instrument accepted by a merchant, according to some embodiments.

FIG. 17 is a flowchart of a method for communicating an amount of savings that a user receives for using a payment instrument to complete a financial transaction with a merchant, according to some embodiments.

FIG. 18 is a flowchart of a method for providing incentives to users for using alternative payment instruments to complete financial transactions, according to some embodiments.

FIG. 19 is a flowchart of a method for determining one or more alternative payment instruments and corresponding incentives to be provided to a user for using the one or more alternative payment instruments in lieu of a first payment instrument to complete the financial transaction with a merchant, according to some embodiments.

FIG. 20 is a flowchart of a method for determining a first cost incurred by a merchant when a first payment instrument is used by the user to complete the financial transaction with the merchant, according to some embodiments.

FIG. 21 is a flowchart of a method for storing information for a payment instrument accepted by a merchant, according to some embodiments.

FIG. 22 is a flowchart of another method for storing information for a payment instrument accepted by a merchant, according to some embodiments.

FIG. 23 is a flowchart of a method for communicating an amount of savings that a user receives for using an alternative payment instrument to complete a financial transaction with a merchant, according to some embodiments.

### DETAILED DESCRIPTION

The embodiments described herein provide techniques for providing incentives to users for using payment instruments to complete financial transactions.

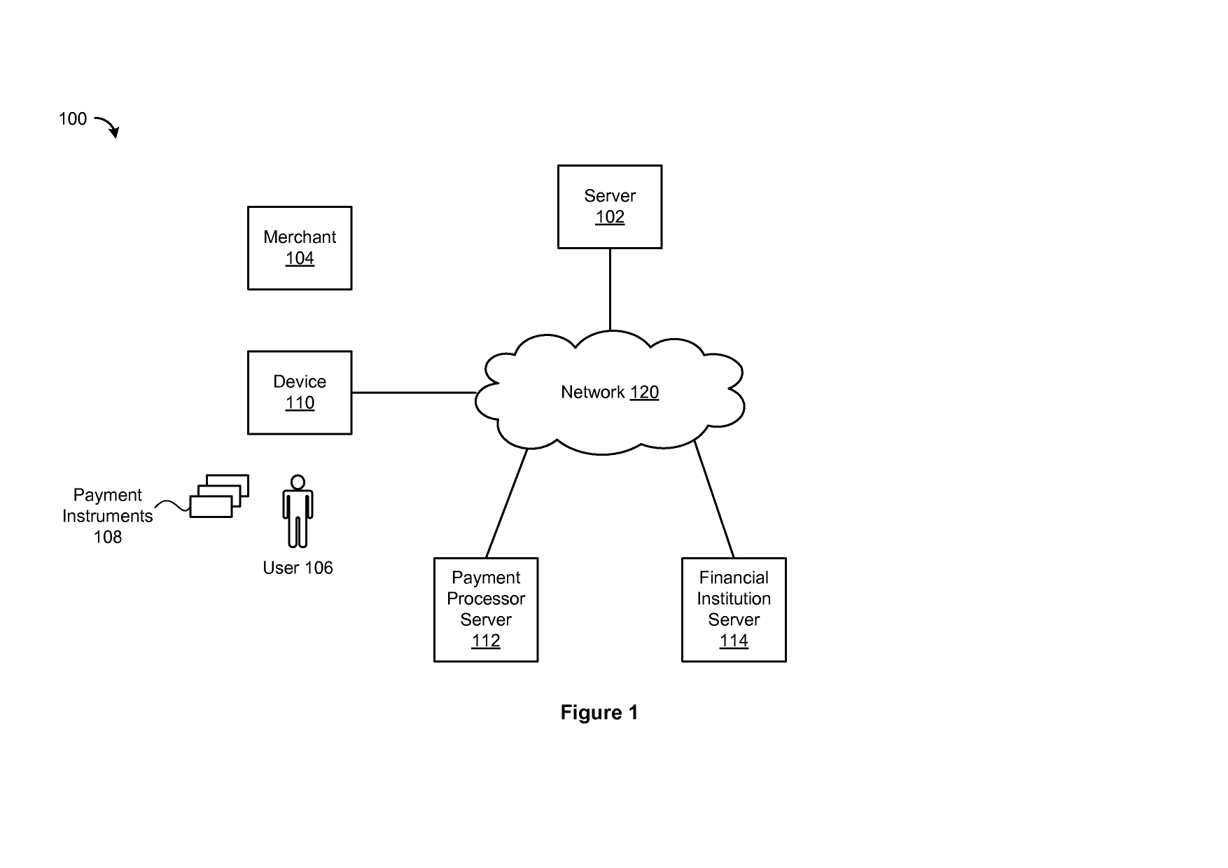

FIG. 1 is a block diagram illustrating a network system 100, according to some embodiments. The network system 100 includes a server 102 coupled to a device 110 via network 120. Network 120 may generally include any type of wired or wireless communication channel capable of coupling together computing nodes. This includes, but is not limited to, a local area network, a wide area network, or a combination of networks. In some embodiments, network 120 includes the Internet.

In some embodiments, server 102 identifies payment instruments 108 (1) that are available to a user 106 and (2) that are associated with incentives provided by a merchant 104 when the user 106 uses at least one of the payment instruments 108 to fulfill a financial transaction with the merchant 104. In some embodiments, an incentive includes one or more of a predetermined discount off of an amount of the financial transaction (sometimes herein called the transaction amount), a redeemable rebate having a predetermined value, a predetermined discount off of a price for a product, a predetermined discount off of a cost for a service, a free product, a free service, a gift card having a predetermined value, and a coupon having a predetermined value.

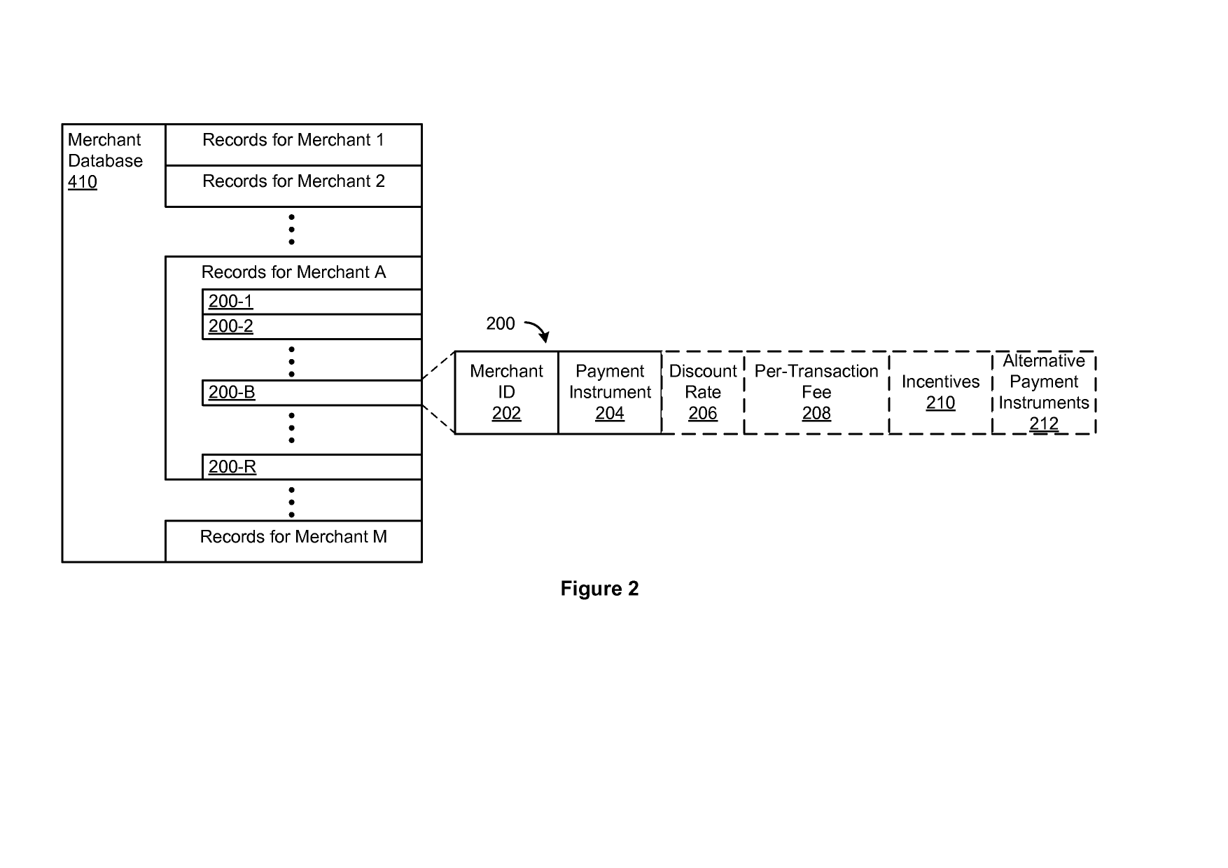

In some embodiments, server 102 identifies the payment instruments 108 based on information identifying the merchant 104 and information identifying the user 106 that are received from device 110. Server 102 is described in more detail below with reference to FIGS. 2-8 and 12-23.

In some implementations, device 110 is a point-of-sale device for the merchant 104. In these implementations, the information identifying the merchant 104 includes, but is not limited to, information obtained from a merchant account (e.g., a merchant bank account or other financial account, an account with a payment processor, etc.) associated with the point-of-sale device for the merchant 104, and/or information included in the point-of-sale device (e.g., a merchant identifier, etc.). The information identifying the user 106 includes, but is not limited to, information obtained from a credit card (or a debit card, or a charge card, etc.) of the user 106 (e.g., a credit card number, a name, an address, etc.) when the credit card is swiped, read by, or manually keyed into the point-of-sale device. Throughout this document, it shall be understood that “swiping” a credit card encompasses swiping a credit card or debit card, and furthermore, in various embodiments, encompasses any automated or manual method of providing information from a credit card or debit card to device 110 (sometimes expressed, from the viewpoint of device 110, as obtaining such information), such as reading a magnetic strip on the card, electronically reading data from the card when the card is inserted into a card reader slot of device 110, using near field communication (NFC) to receive information from the card, reading an RFID (radio frequency identifier) in the card, or optically scanning a bar code or two dimensional code or other visually viewable information on the card.

In some implementations, device 110 is a mobile electronic device for the user 106 (e.g., a smart phone, a mobile phone, a tablet, a personal digital assistant, etc.). In these implementations, the information identifying the merchant 104 includes, but is not limited to, information obtained from a barcode (e.g., a 1-dimensional barcode, a 2-dimensional barcode, etc.) associated with the merchant 104, an alphanumeric code associated with the merchant 104, and/or geographic location of the merchant 104 (e.g., a GPS coordinate) obtained from a positioning system of the mobile electronic device (e.g., a GPS receiver of the mobile device) that is cross-referenced with a directory of businesses that include geographic locations of the businesses. Note that barcode and/or the alphanumeric code may be displayed in conjunction with a product or service provided by the merchant 104. In the case of a barcode, the mobile electronic device may scan the barcode to obtain the information identifying the merchant 104. In the case of an alphanumeric code, the user 106 of the mobile electronic device may enter the alphanumeric code into the mobile electronic device. The information identifying the user 106 includes, but is not limited to, information obtained from the mobile electronic device of the user 106 (e.g., a phone number associated with the mobile device, an IMEI number associated with mobile device, a MAC address associated with the mobile device, and/or login credentials for the user 106 provided by a mobile application executing on the mobile device, etc.).

In some embodiments, device 110 is an interactive kiosk (e.g., a computer system including a user interface—keyboard, mouse, display, etc.). For example, the interactive kiosk may be located in a store (or building) for the merchant 104. In these implementations, the information identifying the merchant 104 includes, but is not limited to, an identifier for the merchant 104 that is included in (or associated with) the interactive kiosk and/or an alphanumeric code associated with the merchant that the user 106 enters into the interactive kiosk (e.g., via a user interface for the interactive kiosk). The information identifying the user 106 includes, but is not limited to, information obtained from a credit card (or a debit card, or a charge card, etc.) of the user 106 when the card is read by the interactive kiosk, a phone number of the user 106 that that the user 106 enters into the interactive kiosk (e.g., via the user interface for the interactive kiosk), and/or login credentials of the user 106 obtained when the user 106 logs into the interactive kiosk (e.g., using the user interface for the interactive kiosk).

In some embodiments, the network system 100 includes a payment processor server 112 and a financial institution server 114. Payment processor server 112 processes authorizes financial transactions between the merchant 104 and the user 106 that involve non-cash payment instruments (e.g., credit cards, debit cards, etc.) and settles the financial transactions with an appropriate financial institution server (e.g., financial institution server 114). After a financial transaction is settled, payment processor server 112 credits a merchant account (e.g., a merchant bank account, an account with a payment processor, etc.) for the merchant 104 in the amount of the financial transaction either before or after any applicable fees have been subtracted.

Note that although FIG. 1 shows one instance for each of server 102, device 110, payment processor server 112, and financial institution server 114, multiple servers, devices, payment processor server, and financial institution servers may be present in the network system 100. For example, each of server 102, payment processor server 112, and financial institution server 114 may include a plurality of distributed servers. The plurality of distributed servers may provide load balancing and/or may provide low-latency points of access to nearby computer systems. The distributed servers may be located within a single location (e.g., a data center, a building, etc.) or may be geographically distributed across multiple locations (e.g., data centers at various geographical locations, etc.).

Also note that although the embodiments described herein refer to server 102, device 110, payment processor server 112, and financial institution server 114, the embodiments may be applied to multiple servers, devices, payment processor servers, and financial institution servers. Furthermore, the functionality of any of server 102, payment processor server 112, and financial institution server 114 may be implemented within a single server (or a set of distributed servers). For example, server 102, payment processor server 112, and financial institution server 114 may be located on the same server (or the same set of distributed servers).

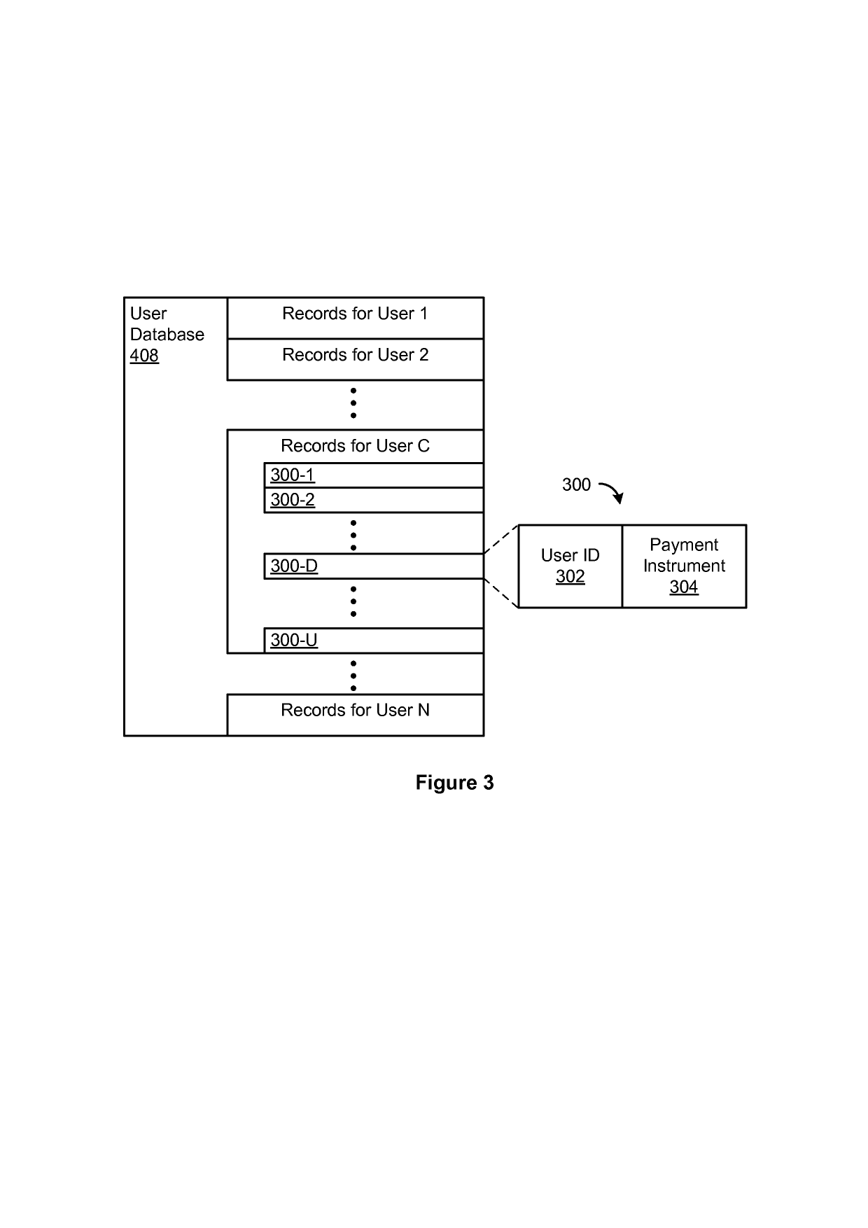

FIGS. 2 and 3 illustrate example data structures for storing information used by server 102 for identifying payment instruments 108 (1) that are available to a user 106 and (2) that are associated with incentives provided by a merchant 104 when the user 106 uses at least one of the payment instruments 108 to fulfill a financial transaction with the merchant 104.

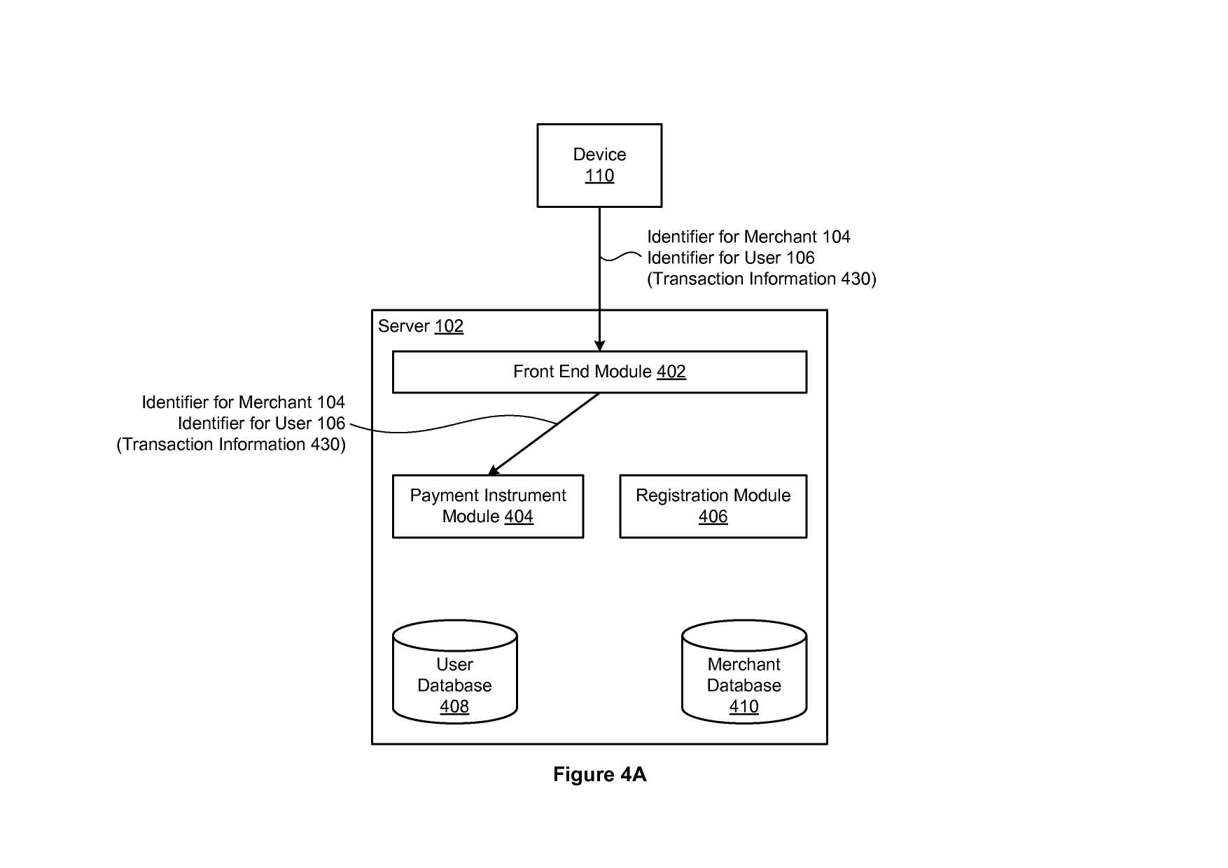

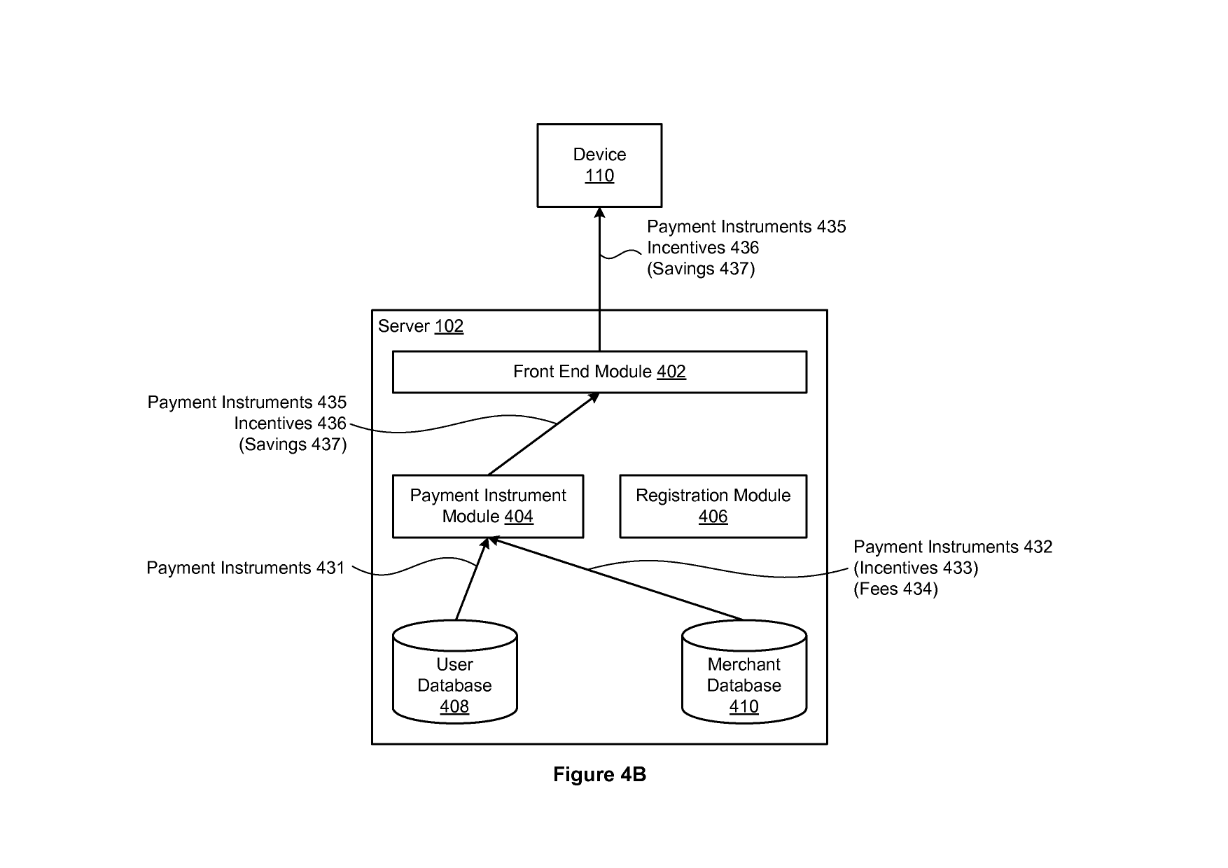

FIG. 2 is a block diagram illustrating a data structure 200 for storing information for payment instruments that are accepted by a merchant, according to some embodiments. The data structure 200 illustrates example data fields for one record of a merchant database (e.g., merchant database 410 of FIG. 4A). The data structure 200 includes a merchant identifier (ID) field 202 for storing an identifier for a merchant and a payment instrument field 204 for storing information identifying a payment instrument that is accepted by the merchant. The data structure 200 also includes at least one of (1) a discount rate field 206 for storing a discount rate that is applied to a transaction amount of a financial transaction when the merchant accepts the payment instrument to fulfill the financial transaction with a user and a per-transaction fee field 208 for storing a fee that is applied to the financial transaction when the merchant accepts the payment instrument to fulfill the financial transaction between the merchant and the user, and (2) an incentives field 210 for storing information for incentives provided by the merchant to the user when the user uses the financial instrument to fulfill a financial transaction with the merchant. In some embodiments, the data structure 200 includes an optional alternative payment instruments field 212 for storing information for alternative payment instruments that the merchant prefers to be used in lieu of the payment instrument (e.g., the payment instrument that is initially proffered by the user to fulfill the financial transaction with the merchant).

Typically, merchant database 410 includes records for multiple merchants, identified in FIG. 2 as merchants 1 though M. The records for a respective merchant, such as Merchant A in FIG. 2, typically include multiple records 200, each storing information for a respective payment instrument accepted by the respective merchant.

In some embodiments, a profile for the merchant 104 is generated from information obtained from at least one record of merchant database 410. For example, the profile for the merchant 104 may be generated from at least a subset of the records of the merchant database whose merchant ID field 202 includes the identifier for the merchant 104.

FIG. 3 is a block diagram illustrating a data structure 300 for storing information for payment instruments available to a user, according to some embodiments. The data structure 300 illustrates example data fields for one record of a user database (e.g., user database 408 of FIG. 4A). The data structure 300 includes a user identifier (ID) field 302 for storing an identifier for a user and a payment instrument field 304 for storing information identifying a payment instrument that is available to the user.

Typically, user database 408 includes records for multiple users, identified in FIG. 3 as users 1 though N. The records for a respective user, such as User D in FIG. 3, typically include multiple records 300, each storing information for a respective payment instrument available to the respective user for making payments (e.g., to buy products or services).

In some embodiments, a profile for the user 106 is generated from information obtained from at least one record of the user database (e.g., the user database 408 of FIG. 4A). For example, the profile for the user 106 may be generated from at least a subset of the records of the user database whose user ID field 302 includes the identifier for the user 106.

Note that the data structures 200 and 300 are merely examples. Other data structures may be used to store the information included in the data structures 200 and 300. For example, multiple data structures may be used to store the information included in the data structure 200. These data structures may be related to each other via foreign keys.

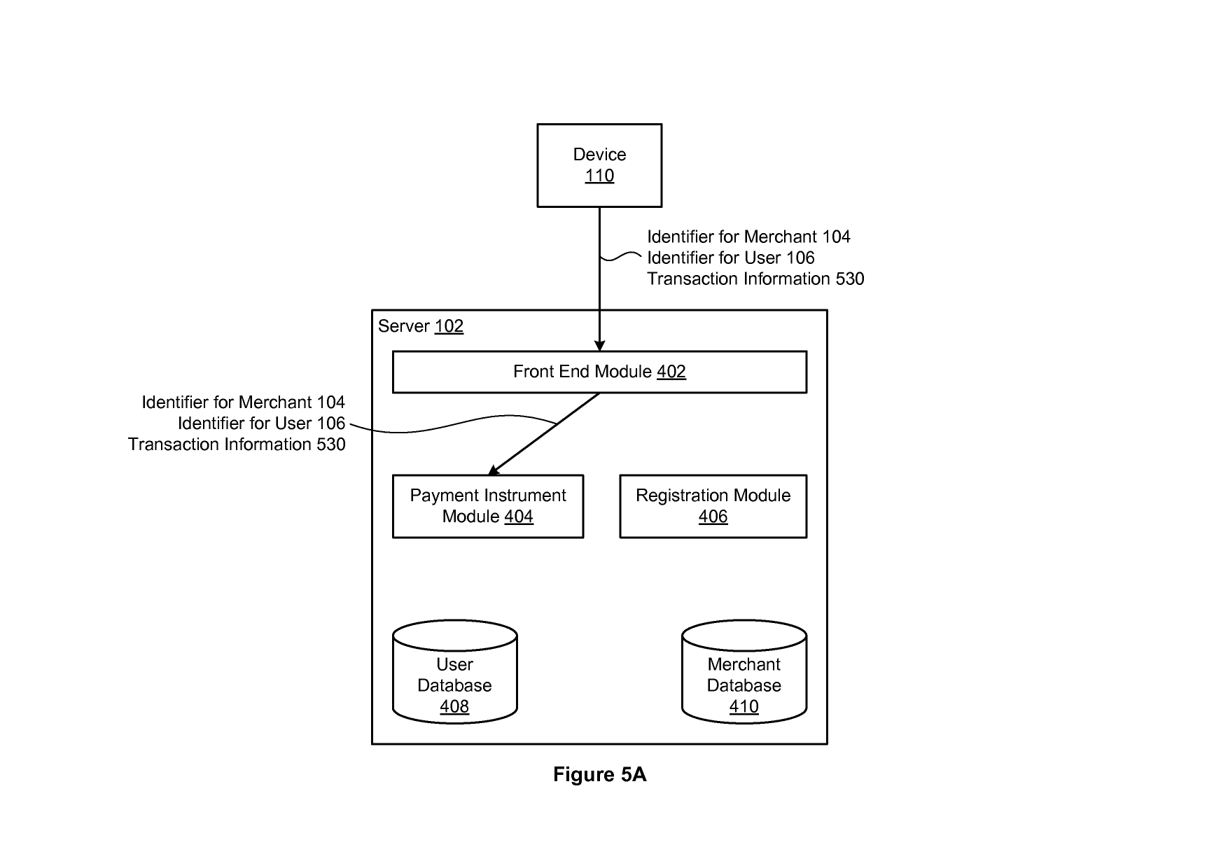

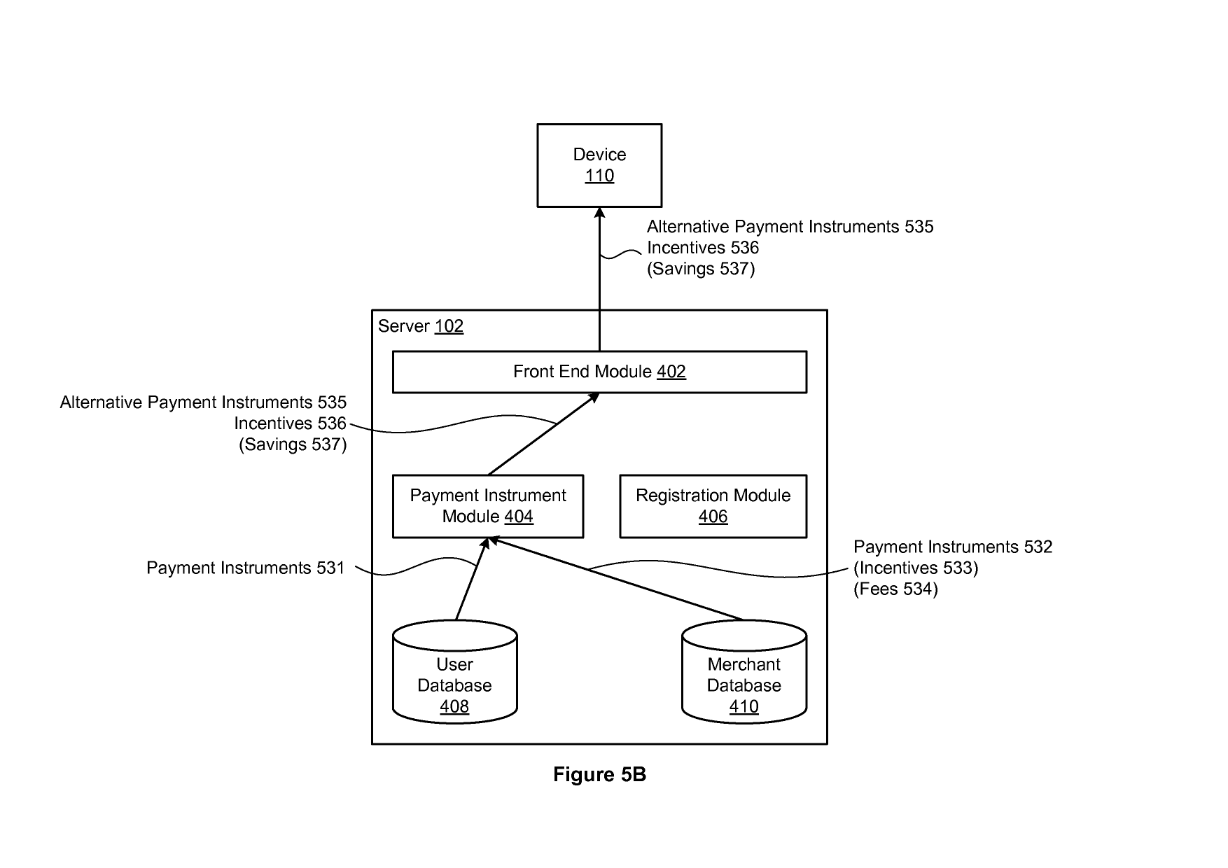

FIGS. 4A, 4B, 5A, and 5B illustrate example processes for identifying payment instruments. The example process illustrated in FIGS. 4A and 4B may be initiated by the user 106 prior to entering a financial transaction with the merchant 104. For example, the user 106 may use an interactive kiosk in a store of the merchant 104 or an application executing on a mobile electronic device of the user 106 to identify incentives that the merchant 104 provides to users for using particular types of payment instruments. The example process illustrated in FIGS. 5A and 5B may be initiated when the user 106 enters a financial transaction with the merchant 104. For example, the example process illustrated in FIGS. 5A and 5B may be initiated when the merchant or user 106 swipes a credit card or the user in a point-of-sale device of the merchant 104.

FIGS. 4A and 4B are block diagrams illustrating a process for identifying payment instruments and associated incentives, according to some embodiments. In some embodiments, the process illustrated in FIGS. 4A and 4B is performed prior to the user 106 starting a financial transaction with the merchant 104 (e.g., prior to the user paying for goods or services). For example, device 110 may be a mobile electronic device of the user 106, and the user 106 may use an application on the mobile electronic device of the user 106 to scan a barcode displayed in the store of the merchant 104 (e.g., a barcode displayed on or next to products, or on a sign or other display or document for services provided by the merchant, etc.) to identify payment instruments that are available to the user 106 and that are associated with incentives provided by the merchant 104 when the user 106 uses the identified payment instruments to fulfill a financial transaction with the merchant 104. In another example, device 110 may be an interactive kiosk in a store of the merchant 104, and the user 106 may log into (or otherwise identify the user 106) to the interactive kiosk to identify payment instruments that are available to the user 106 and that are associated with incentives provided by the merchant 104 when the user 106 uses the identified payment instruments to fulfill a financial transaction with the merchant 104. In another example, device 110 may be computer system of the user 106, and the user 106 may log into (or otherwise identify the user 106) to a website of the merchant 104 (or to a website provided by server 102) to identify payment instruments that are available to the user 106 and that are associated with incentives provided by the merchant 104 when the user 106 uses the identified payment instruments to fulfill a financial transaction with the merchant 104.

In some embodiments, the process illustrated in FIGS. 4A and 4B is performed when the user 106 is fulfilling a financial transaction with the merchant 104. For example, the process illustrated in FIGS. 4A and 4B may be performed in response to the user 106 swiping a credit card in a point-of-sale device of the merchant 104.

As illustrated in FIG. 4A, device 110 transmits an identifier for the merchant 104 and an identifier for the user 106 to server 102. A front end module 402 of server 102 receives the identifier for the merchant 104 and the identifier for the user 106 and provides the identifier for the merchant 104 and the identifier for the user 106 to a payment instrument module 404.

Referring to FIG. 4B, the payment instrument module 404 uses the identifier for the merchant 104 to obtain, from merchant database 410, information identifying payment instruments 432 that the merchant 104 accepts and at least one of (1) incentives 433 that are provided by the merchant 104 when a user uses respective payment instruments 432 to fulfill a financial transaction with the merchant 104 and (2) fees 434 (e.g., discount rate, per-transaction fee, etc.) that are incurred by the merchant 104 when the identified payment instruments are used by a user to fulfill a financial transaction with the merchant 104. In implementations where the incentives 433 are obtained from merchant database 410, each of the respective payment instruments 432 is associated with at least one of the incentives 433. In implementations where the payment instrument module 404 obtains the fees 434 from merchant database 410, each of the respective payment instruments 432 is associated with at least one of the fees 434 (e.g., a respective discount rate, a respective per-transaction fee, etc.).

The payment instrument module 404 uses the identifier for the user 106 to obtain, from the user database 408, information identifying payment instruments 431 that are available to the user 106.

The payment instrument module 404 then uses the information identifying the payment instruments 431 that are available to the user 106, the information identifying the payment instruments 432 that the merchant 104 accepts and at least one of (1) the incentives 433 and (2) the fees 434, to identify payment instruments 435 that are available to the user 106 and that are associated with incentives 436 that are provided by the merchant 104 when the user 106 uses the one of the identified payment instruments 435 to fulfill a financial transaction with the merchant 104. The payment instrument module 404 provides information identifying payment instruments 435 and incentives 436 to the front end module 402, which in turn transmits information identifying payment instruments 435 and incentives 436 to device 110. Device 110 then presents the identified payment instruments 435 and corresponding incentives 436 to the user 106 or the merchant (e.g., in a user interface of device 110).

In some embodiments, device 110 transmits transaction information 430 to server 102. The transaction information 430 includes, but is not limited to, one or more of an amount of the transaction, an identifier for a product (e.g., a barcode, a UPC code, etc.), and an identifier for a service. The transaction information 430 may be obtained from an actual financial transaction between the user 106 and the merchant 104 (e.g., at a checkout register of the merchant 104) or may be obtained from a hypothetical financial transaction between the user 106 and the merchant 104 (e.g., by scanning product barcodes into an interactive kiosk or into an application executing on a mobile electronic device). The front end module 402 receives the transaction information 430 and provides the transaction information 430 to the payment instrument module 404. For at least one of the identified payment instruments 435, the payment instrument module 404 uses the transaction information 430 and the incentives 436 to determine an amount of savings 437 that the user 106 receives when using the those payment instruments 435. For example, if the incentive for a respective payment instruments 435 is a 1% discount off of an amount of the financial transaction, the payment instrument module 404 calculates the amount of savings 437 as a product of the 1% and the transaction amount. When there is more than one payment instrument, the payment instrument module 404 may calculate the amount of savings 437 that the user 106 receives when using each of the payment instruments 435. The payment instrument module 404 then provides the savings 437 to the front end module 402, which in turn transmits the savings 437 to device 110. Device 110 then presents the savings 437 along with the corresponding payment instruments 435, and optionally also presents the corresponding incentives 436 to the user 106 or the merchant 104 (e.g., in a user interface of device 110). Typically, the incentives 436 differ from the savings 437 in that the incentives are expressed in a general form that is not specific to a particular transaction, while the savings 437 are an amount of savings for a particular transaction. Stated another way, a respective incentive 436 is a rule for computing or otherwise determining the corresponding savings 437 for a particular transaction.

FIGS. 5A and 5B are block diagrams illustrating a process for identifying alternative payment instruments and associated incentives, according to some embodiments. In some embodiments, the process illustrated in FIGS. 5A and 5B is performed when the user 106 is fulfilling a financial transaction with the merchant 104. For example, device 110 may be a point-of-sale device for the merchant 104, and the process illustrated in FIGS. 5A and 5B is performed in response to the point-of-sale device identifying the user 106 (e.g., after a credit card of the user is swiped in the point-of-sale device). In another example, device 110 may be a computer system (or mobile electronic device) of the user 106, and the process illustrated in FIGS. 5A and 5B is performed in response to the user 106 initiating a checkout process on a website of the merchant 104.

As illustrated in FIG. 5A, device 110 transmits an identifier for the merchant 104, an identifier for the user 106, and transaction information 530 to server 102. In some embodiments, device 110 transmits the identifier for the merchant 104, the identifier for the user 106, and the transaction information 530 to server 102 in response to receiving information for a payment instrument of the user 106 (e.g., in response to a credit card for the user 106 being swiped in a point-of-sale device of the merchant 104, in response to receiving information for a credit card of the user that is stored on a website for the merchant 104, etc.).

The front end module 402 of server 102 receives the identifier for the merchant 104, the identifier for the user 106, and the transaction information 530 and provides the identifier for the merchant 104, the identifier for the user 106, and the transaction information 530 to the payment instrument module 404.

Referring to FIG. 5B, the payment instrument module 404 uses the identifier for the merchant 104 to obtain, from merchant database 410, information identifying payment instruments 532 that the merchant 104 accepts and at least one of (1) incentives 533 that are provided by the merchant 104 when a user uses the payment instruments 532 to fulfill a financial transaction with the merchant 104 and (2) fees 534 (e.g., a discount rate, a per-transaction fee, etc.) that are incurred by the merchant 104 when the payment instruments are used by a user to fulfill a financial transaction with the merchant 104. In implementations where the payment instrument module 404 obtains the incentives 533 from merchant database 410, each of the payment instruments 532 is associated with at least one of the incentives 533. In implementations where the payment instrument module 404 obtains the fees 534 from merchant database 410, each of the payment instruments 532 is associated with at least one of the fees 534 (e.g., a respective discount rate, a respective per-transaction fee, a combination of such fees, etc.).

The payment instrument module 404 uses the identifier for the user 106 to obtain, from the user database 408, information identifying payment instruments 531 that are available to the user 106.

The payment instrument module 404 then uses the information identifying the payment instruments 531 that are available to the user 106, the information identifying the payment instruments 532 that the merchant 104 accepts and at least one of (1) the incentives 533 and (2) the fees 534 to identify alternative payment instruments 535 that are available to the user 106 and that are associated with incentives 536 that are provided by the merchant 104 when the user 106 uses the one of the alternative payment instruments 535 to fulfill a financial transaction with the merchant 104 in lieu of a payment instrument initially proffered by the user 106. The payment instrument module 404 provides the alternative payment instruments 535 and the incentives 536 to the front end module 402, which in turn transmits the alternative payment instruments 535 and the incentives 536 to device 110. Device 110 then presents the alternative payment instruments 535 and the corresponding incentives 536 to the user 106 (e.g., in a user interface of device 110).

In some embodiments, for at least one of the alternative payment instruments 535, the payment instrument module 404 uses the transaction information 530 and the incentives 536 to determine an amount of savings 537 that the user 106 receives when using the at least one of the alternative payment instruments 535. For example, if the incentive for the at least one of the alternative payment instruments 535 is a 1% discount off of an amount of the financial transaction, the payment instrument module 404 calculates the amount of savings 537 as a product of the 1% and the transaction amount. When there is more than one alternative payment instrument, the payment instrument module 404 optionally calculates the amount of savings 537 that the user 106 would receive when using each of the alternative payment instruments 535. Alternatively, when there is more than one alternative payment instrument, the payment instrument module 404 calculates the amount of savings 537 that the user 106 would receive when using each of a subset of the alternative payment instruments 535. The payment instrument module 404 then provides the savings 537 to the front end module 402, which in turn transmits the savings 537 to device 110. Device 110 then presents the savings 537 along with the corresponding alternative payment instruments 535, and optionally also presents the corresponding incentives 536 to the user 106 or to the merchant 104 (e.g., in a user interface of device 110).

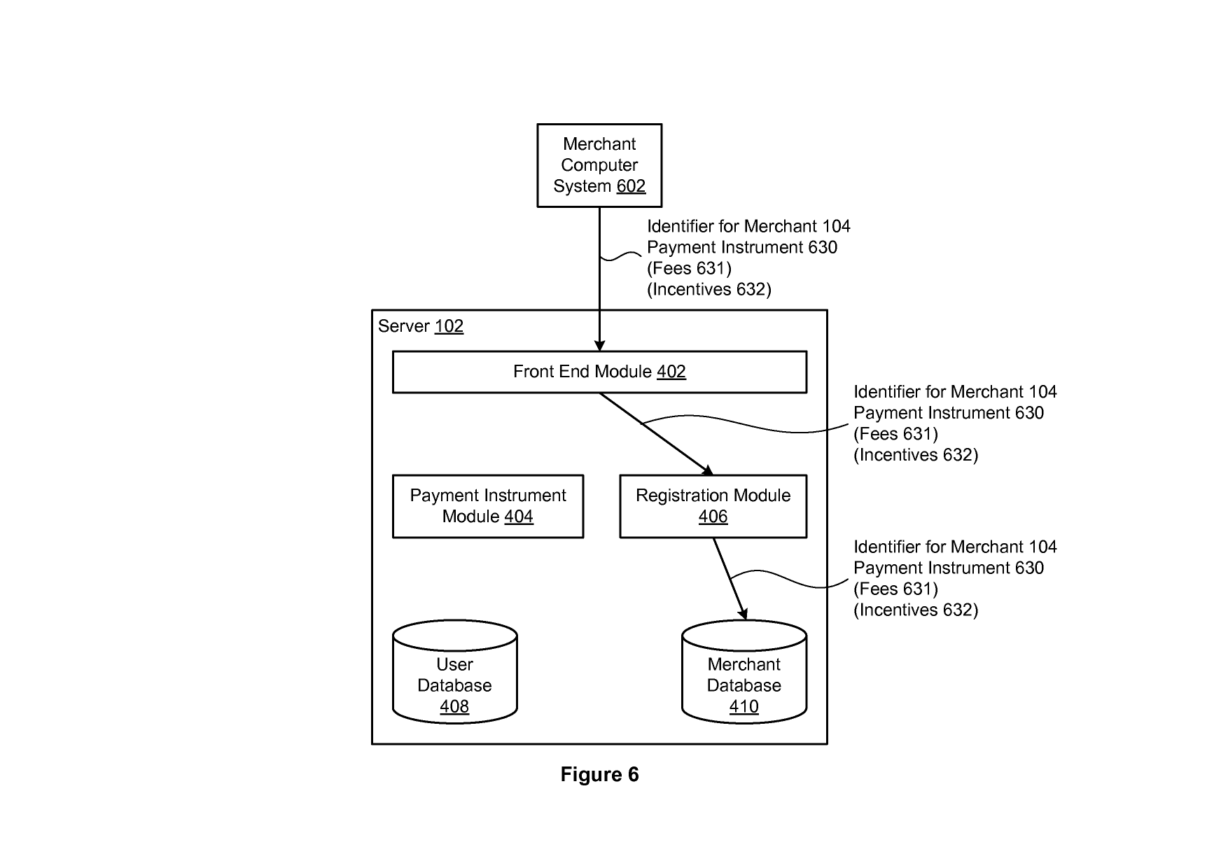

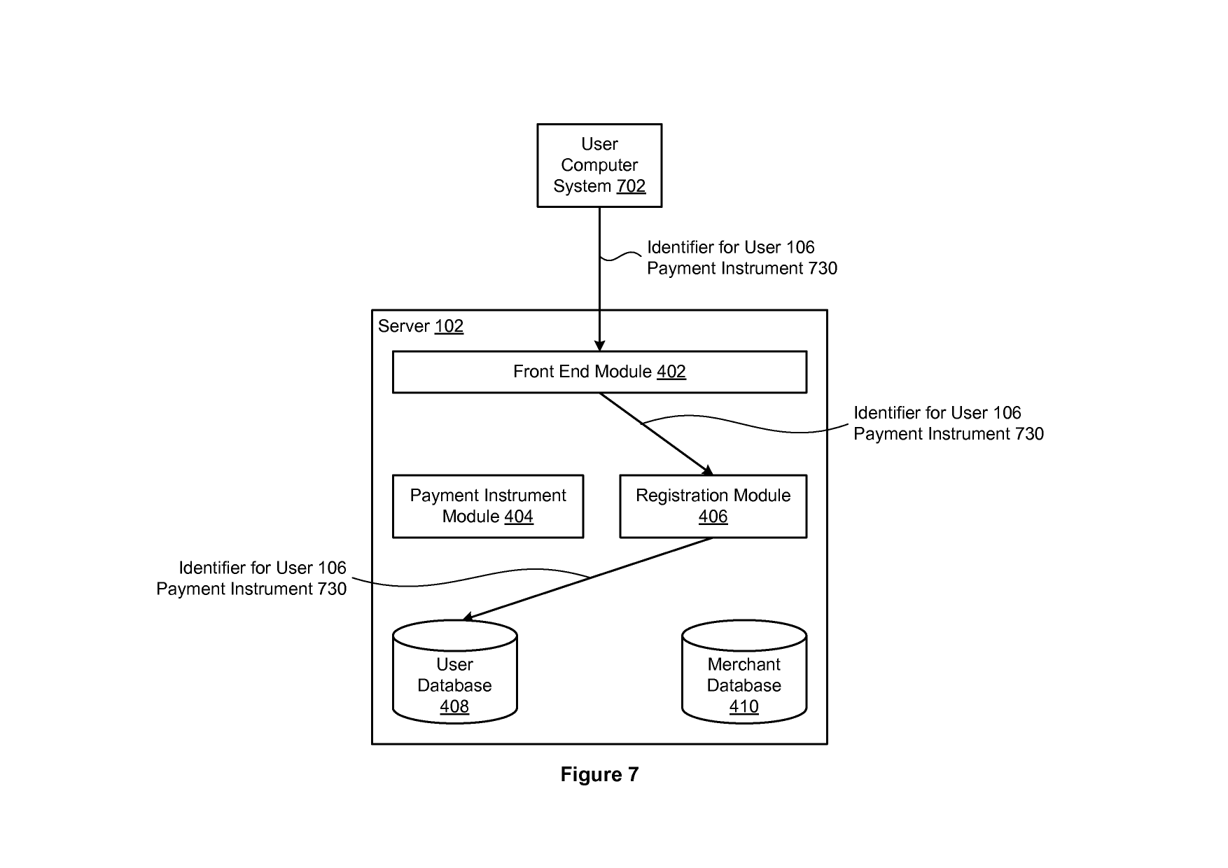

In some embodiments, prior to performing the processes discussed above with reference to FIGS. 4A, 4B, 5A, and 5B, the merchant 104 provides information for payment instruments that the merchant 104 accepts and the user 106 provides information for payment instruments that are available to the user 106. In some other embodiments, the user 106 provides information for payment instruments that are available to the user 106 after initiating the processes illustrated in FIGS. 4A, 4B, 5A, and 5B. For example, the user 106 may attempt to use device 110 to identify payment instruments that the merchant 104 accepts and that are associated with incentives provided by the merchant 104 when the user 106 uses the payment instruments to fulfill a financial transaction with the merchant 104. However, server 102 may determine that the user 106 has not previously provided the information for payment instruments that are available to the user 106 to server 102. Accordingly, server 102 may request that the user 106 provide information for payment instruments that are available to the user 106. FIGS. 6 and 7 illustrate example processes for storing information for payment instruments that are accepted by a merchant and information for payment instruments that are available to a user, respectively.

FIG. 6 is a block diagram illustrating a process for storing information for payment instruments that are accepted by a merchant (e.g., the merchant 104), according to some embodiments. As illustrated in FIG. 6, the merchant 104 uses a merchant computer system 602 (e.g., a laptop computer system, a desktop computer system, a smart phone, etc.) to transmit, to server 102, an identifier for the merchant 104, information identifying a payment instrument 630 that is accepted by the merchant 104, and at least one of (1) fees 631 (e.g., a discount rate, a per-transaction fee, etc.) associated with the payment instrument 630 and (2) one or more incentives 632 associated with the payment instrument 630. Fees 631 are sometimes herein called merchant fees. The merchant fee for a particular transaction is paid by the merchant 104 from the gross amount of a respective payment made by a customer. Typically, the merchant fee is deducted from the amount paid by the customer, and the resulting net amount is deposited in a financial account of the merchant 104.

The front end module 402 of server 102 receives the identifier for the merchant 104, the information identifying the payment instrument 630, and at least one of (1) the fees 631 associated with the payment instrument 630 and (2) the one or more incentives 632 associated with the payment instrument 630 and provides these data items to the registration module 406, which in turn stores these data items into at least one record of merchant database 410 (e.g., using the data structure 200).

Alternatively, server 102 receives information identifying payment instruments 630 and fees 631 for the merchant 104 from a service provider associated with the merchant 104. The service provider would typically be a service provider who provides credit card and debit card clearance services for the merchant 104. As a result, the service provider is privy to the fees 631 associated with each payment instrument accepted by the merchant. In these embodiments, either the merchant or the service provider provides the incentives 632. For example, the merchant may prefer to determine and provide the incentives 632 to server 102. Alternatively, the service provider may offer one or more predefined incentives schedules, and the merchant may select one of those incentives schedules; in these embodiments server 102 receives incentives 632 for one or more payment instruments associated with the merchant from the merchant's service provider.

FIG. 7 is a block diagram illustrating a process for storing information for payment instruments that are available to a user (e.g., the user 106), according to some embodiments. As illustrated in FIG. 7, the user 106 uses a user computer system 702 (e.g., a laptop computer system, a desktop computer system, a smart phone, etc.) to transmit, to server 102, an identifier for the user 106 and information identifying a payment instrument 730 that is available to the user 106.

The front end module 402 of server 102 receives the identifier for the user 106 and the information identifying a payment instrument 730 and provides these data items to the registration module 406, which in turn stores these data items into at least one record of the user database 408 (e.g., using the data structure 300).

Typically, the user 106 would repeat this process for each payment instrument that the user might want to use when making a purchase from a respective merchant. In some implementations, the user 106 is incentivized to provide this information in order to be eligible to receive discounts or other incentives from merchants. In some implementations, the user 106 is eligible to receive a discount even without pre-registration of the user's payment instruments, but registering the user's payment instruments in advance greatly facilitates the process of being offered discounts or other incentives from participating merchants.

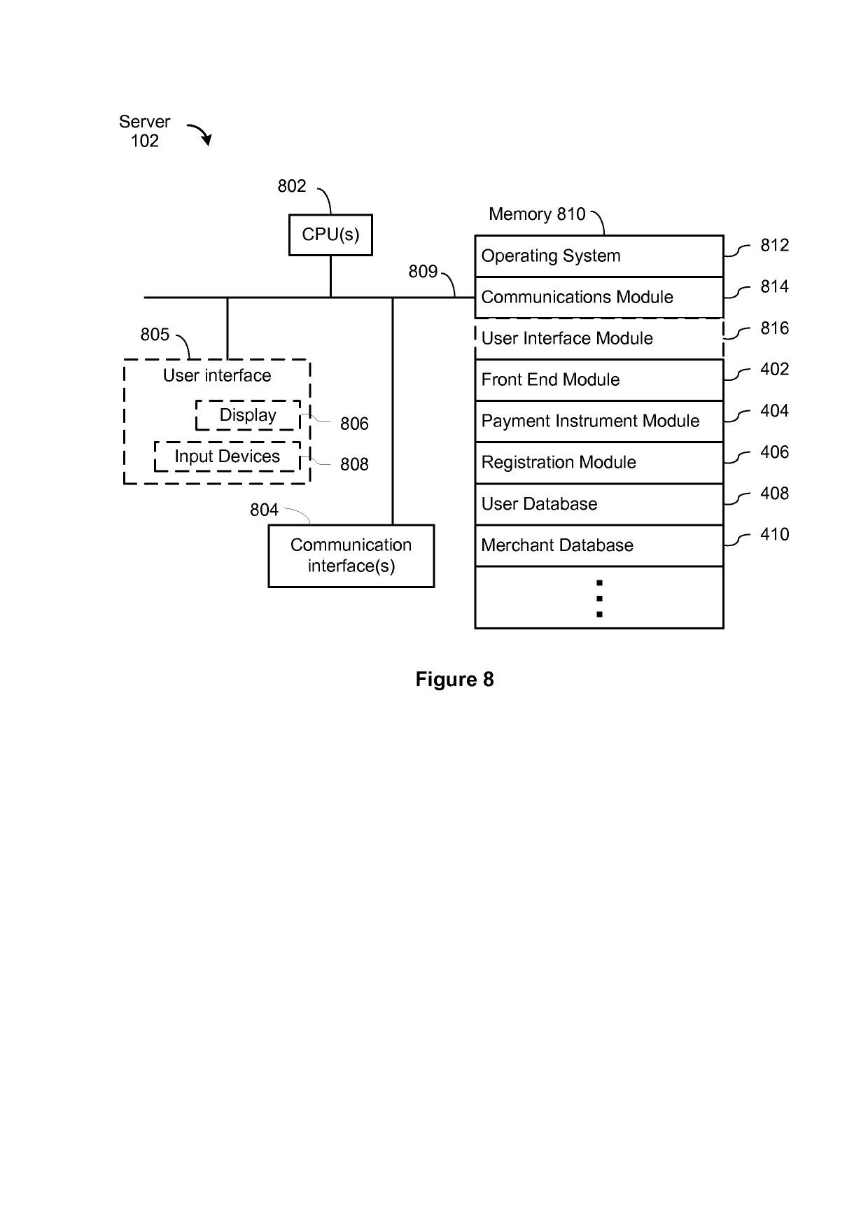

FIG. 8 is a block diagram illustrating server 102, according to some embodiments. Server 102 typically includes one or more processing units (CPU's, sometimes called processors) 802 for executing programs (e.g., programs stored in memory 810), one or more network or other communications interfaces 804, memory 810, and one or more communication buses 809 for interconnecting these components. The communication buses 809 may include circuitry (sometimes called a chipset) that interconnects and controls communications between system components. Server 102 optionally includes (but typically does not include) a user interface 805 comprising a display device 806 and input devices 808 (e.g., keyboard, mouse, touch screen, keypads, etc.). Memory 810 includes high-speed random access memory, such as DRAM, SRAM, DDR RAM or other random access solid state memory devices; and typically includes non-volatile memory, such as one or more magnetic disk storage devices, optical disk storage devices, flash memory devices, or other non-volatile solid state storage devices. Memory 810 optionally includes one or more storage devices remotely located from the CPU(s) 802. Memory 810, or alternately the non-volatile memory device(s) within memory 810, comprises a non-transitory computer readable storage medium. In some embodiments, memory 810 or the computer readable storage medium of memory 810 stores the following programs, modules and data structures, or a subset thereof:
an operating system 812 that includes procedures for handling various basic system services and for performing hardware dependent tasks;
a communication module 814 that is used for connecting server 102 to other computers via the one or more communication interfaces 804 (wired or wireless) and one or more communication networks, such as the Internet, other wide area networks, local area networks, metropolitan area networks, and so on;
an optional user interface module 816 that receives commands from the user via the input devices 808 and generates user interface objects in the display device 806;
front end module 402, which provides an interface between server 102 and other computer systems, as described herein;
payment instrument module 404, which identifies payment instruments that are available to a user and that are associated with incentives provided by a merchant when the users use the payment instruments to fulfill a financial transaction with the merchant, as described herein;
registration module 406, which registers payment instruments that are available to users and/or that registers payment instruments that are accepted by merchants, fees associated with the payment instruments, incentives that are provided by the merchant when the payment instruments are used by a user to fulfill a financial transaction with the merchant, and/or alternative payment instruments, as described herein;
the user database 408 that stores information identifying payment instruments that are available to users, as described herein; and
merchant database 410 that stores information identifying payment instruments that are accepted by merchants, fees associated with the payment instruments, incentives that are provided by the merchant when the payment instruments are used by a user to fulfill a financial transaction with the merchant, and/or alternative payment instruments, as described herein.

In some embodiments, the programs or modules identified above correspond to sets of instructions for performing a function described above. The sets of instructions can be executed by one or more processors (e.g., the CPUs 802). The above identified modules or programs (i.e., sets of instructions) need not be implemented as separate software programs, procedures or modules, and thus various subsets of these programs or modules may be combined or otherwise re-arranged in various embodiments. In some embodiments, memory 810 stores a subset of the modules and data structures identified above. Furthermore, memory 810 may store additional modules and data structures not described above.

Although FIG. 8 shows a “server,” FIG. 8 is intended more as functional description of the various features which may be implemented in a set of servers than as a structural schematic of the embodiments described herein. In practice, and as recognized by those of ordinary skill in the art, items shown separately could be combined and some items could be separated. For example, some items shown separately in FIG. 8 could be implemented on single servers and single items could be implemented by one or more servers. The actual number of servers and how features are allocated among them will vary from one implementation to another, and may depend in part on the amount of data traffic that the system must handle during peak usage periods as well as during average usage periods.

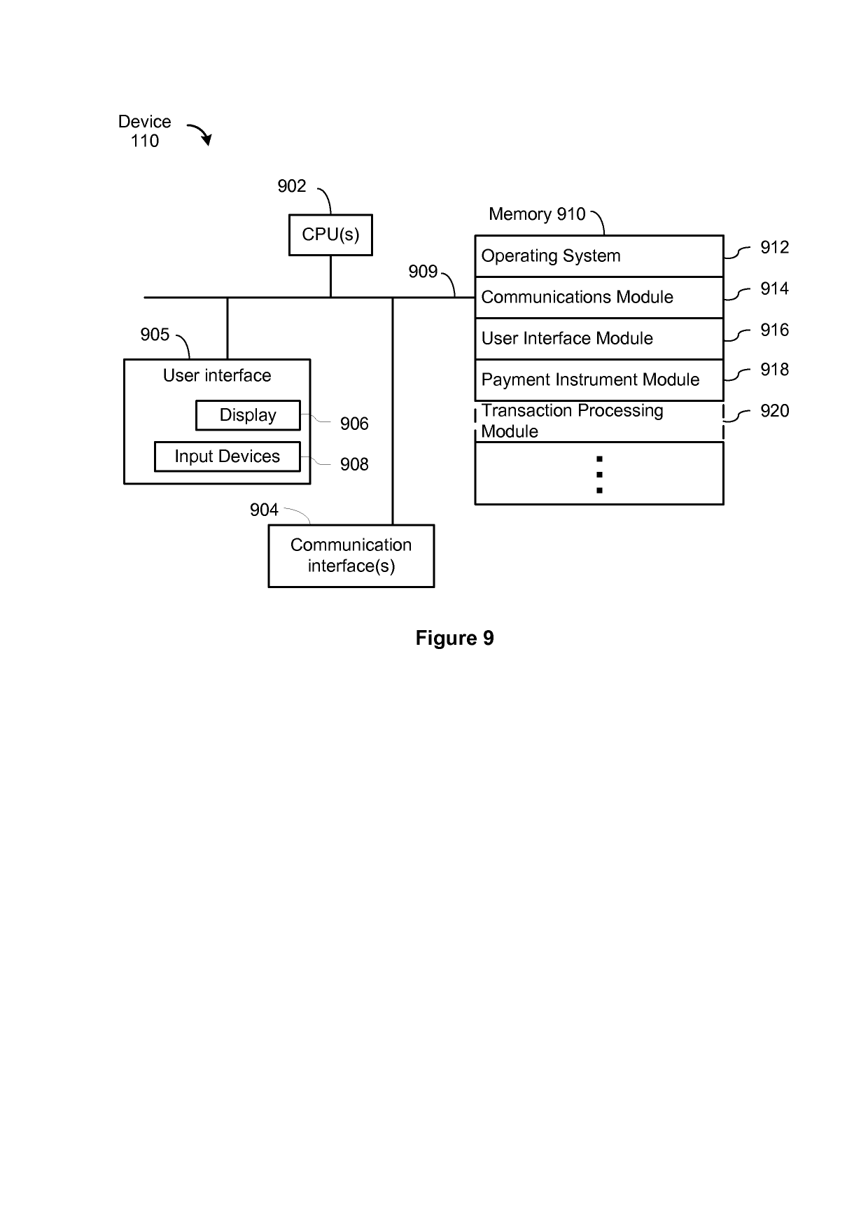

FIG. 9 is a block diagram illustrating device 110, according to some embodiments. Device 110 typically includes one or more processing units (CPU's, sometimes called processors) 902 for executing programs (e.g., programs stored in memory 910), one or more network or other communications interfaces 904, memory 910, and one or more communication buses 909 for interconnecting these components. The communication buses 909 may include circuitry (sometimes called a chipset) that interconnects and controls communications between system components. Device 110 includes a user interface 905, which typically comprises a display device 906 and input devices 908 (e.g., keyboard, mouse, touch screen, keypads, etc.). Memory 910 includes high-speed random access memory, such as DRAM, SRAM, DDR RAM or other random access solid state memory devices; and typically includes non-volatile memory, such as one or more magnetic disk storage devices, optical disk storage devices, flash memory devices, or other non-volatile solid state storage devices. Memory 910 optionally includes one or more storage devices remotely located from the CPU(s) 902. Memory 910, or alternately the non-volatile memory device(s) within memory 910, comprises a non-transitory computer readable storage medium. In some embodiments, memory 910 or the computer readable storage medium of memory 910 stores the following programs, modules and data structures, or a subset thereof:
an operating system 912 that includes procedures for handling various basic system services and for performing hardware dependent tasks;
a communication module 914 that is used for connecting device 110 to other computers via the one or more communication interfaces 904 (wired or wireless) and one or more communication networks, such as the Internet, other wide area networks, local area networks, metropolitan area networks, and so on;
a user interface module 916 that receives commands from the user via the input devices 908 and generates user interface objects in the display device 906;
a payment instrument module 916 (or a payment instrument application) that provides a user interface for a user to provide information identifying the user to the payment instruments module 404 of server 102 and to display, on the display 906 of device 110, information relating to payment instruments that are available to the user and that are associated with incentives provided by the merchant when the user uses the payment instruments to fulfill a financial transaction with the merchant, as described herein; and
an optional transaction processing module that receives information for a payment instrument (e.g., information received from a credit card in response to a swipe of a credit card, etc.) and provides the information for the payment instrument to payment processor server 112 to authorize a financial transaction between a user and a merchant, as described herein.

In some embodiments, the programs or modules identified above correspond to sets of instructions for performing a function described above. The sets of instructions can be executed by one or more processors (e.g., the CPUs 902). The above identified modules or programs (i.e., sets of instructions) need not be implemented as separate software programs, procedures or modules, and thus various subsets of these programs or modules may be combined or otherwise re-arranged in various embodiments. In some embodiments, memory 910 stores a subset of the modules and data structures identified above. Furthermore, memory 910 may store additional modules and data structures not described above.

Although FIG. 9 shows a “device,” FIG. 9 is intended more as functional description of the various features which may be present in a device than as a structural schematic of the embodiments described herein. In practice, and as recognized by those of ordinary skill in the art, items shown separately could be combined and some items could be separated.

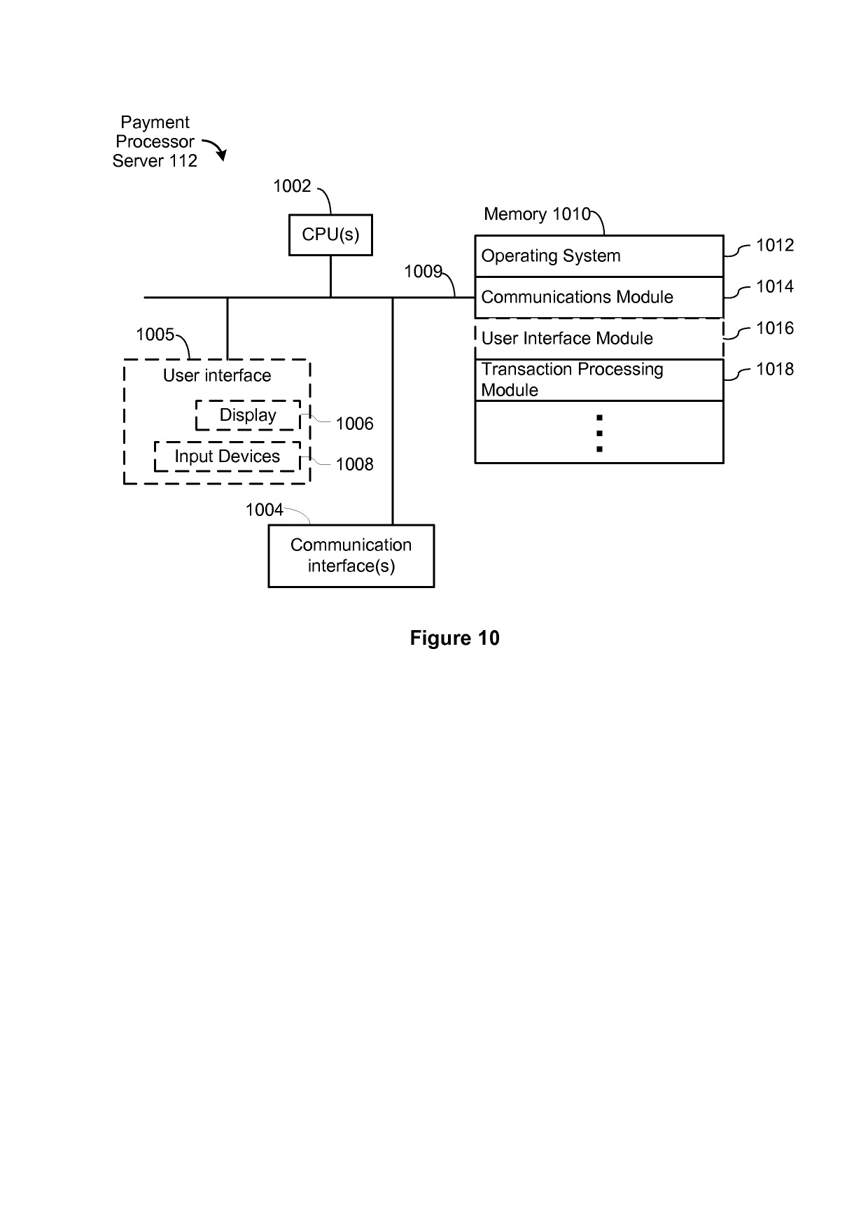

FIG. 10 is a block diagram illustrating payment processor server 112, according to some embodiments. Payment processor server 112 typically includes one or more processing units (CPU's, sometimes called processors) 1002 for executing programs (e.g., programs stored in memory 1010), one or more network or other communications interfaces 1004, memory 1010, and one or more communication buses 1009 for interconnecting these components. The communication buses 1009 may include circuitry (sometimes called a chipset) that interconnects and controls communications between system components. Payment processor server 112 optionally includes (but typically does not include) a user interface 1005 comprising a display device 1006 and input devices 1008 (e.g., keyboard, mouse, touch screen, keypads, etc.). Memory 1010 includes high-speed random access memory, such as DRAM, SRAM, DDR RAM or other random access solid state memory devices; and typically includes non-volatile memory, such as one or more magnetic disk storage devices, optical disk storage devices, flash memory devices, or other non-volatile solid state storage devices. Memory 1010 optionally includes one or more storage devices remotely located from the CPU(s) 1002. Memory 1010, or alternately the non-volatile memory device(s) within memory 1010, comprises a non-transitory computer readable storage medium. In some embodiments, memory 1010 or the computer readable storage medium of memory 1010 stores the following programs, modules and data structures, or a subset thereof:
an operating system 1012 that includes procedures for handling various basic system services and for performing hardware dependent tasks;
a communication module 1014 that is used for connecting payment processor server 112 to other computers via the one or more communication interfaces 1004 (wired or wireless) and one or more communication networks, such as the Internet, other wide area networks, local area networks, metropolitan area networks, and so on;
an optional user interface module 1016 that receives commands from the user via the input devices 1008 and generates user interface objects in the display device 1006; and
a transaction processing module 1018 that authorizes financial transactions that involve non-cash payment instruments (e.g., credit cards, debit cards, etc.) between users and merchants with a financial institution server 114.

In some embodiments, the programs or modules identified above correspond to sets of instructions for performing a function described above. The sets of instructions can be executed by one or more processors (e.g., the CPUs 1002). The above identified modules or programs (i.e., sets of instructions) need not be implemented as separate software programs, procedures or modules, and thus various subsets of these programs or modules may be combined or otherwise re-arranged in various embodiments. In some embodiments, memory 1010 stores a subset of the modules and data structures identified above. Furthermore, memory 1010 may store additional modules and data structures not described above.

Although FIG. 10 shows a “payment processor server,” FIG. 10 is intended more as functional description of the various features which may be present in a set of payment processor servers than as a structural schematic of the embodiments described herein. In practice, and as recognized by those of ordinary skill in the art, items shown separately could be combined and some items could be separated. For example, some items shown separately in FIG. 10 could be implemented on single servers and single items could be implemented by one or more servers. The actual number of servers used to implement a payment processor server and how features are allocated among them will vary from one implementation to another, and may depend in part on the amount of data traffic that the system must handle during peak usage periods as well as during average usage periods.

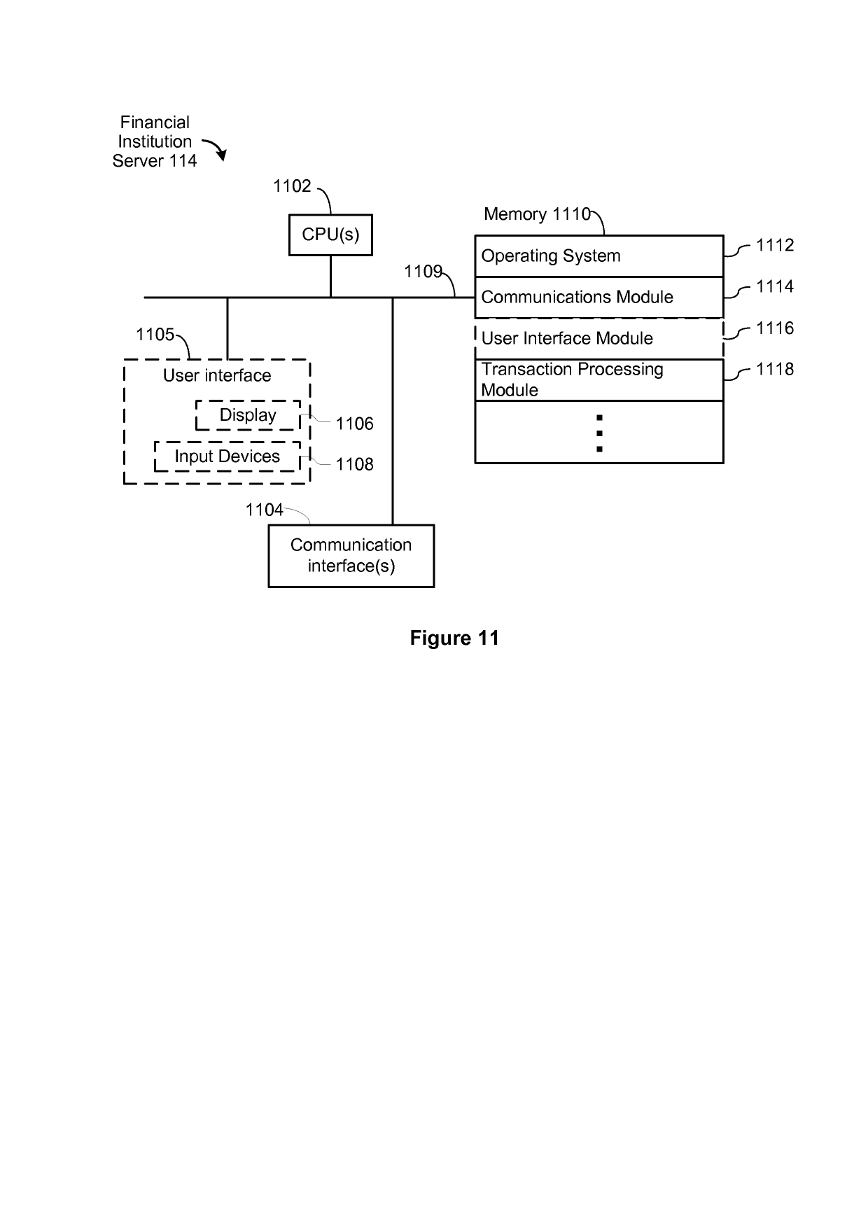

FIG. 11 is a block diagram illustrating financial institution server 114, according to some embodiments. Financial institution server 114 typically includes one or more processing units (CPU's, sometimes called processors) 1102 for executing programs (e.g., programs stored in memory 1110), one or more network or other communications interfaces 1104, memory 1110, and one or more communication buses 1109 for interconnecting these components. The communication buses 1109 may include circuitry (sometimes called a chipset) that interconnects and controls communications between system components. Financial institution server 114 optionally includes (but typically does not include) a user interface 1105 comprising a display device 1106 and input devices 1108 (e.g., keyboard, mouse, touch screen, keypads, etc.). Memory 1110 includes high-speed random access memory, such as DRAM, SRAM, DDR RAM or other random access solid state memory devices; and typically includes non-volatile memory, such as one or more magnetic disk storage devices, optical disk storage devices, flash memory devices, or other non-volatile solid state storage devices. Memory 1110 optionally includes one or more storage devices remotely located from the CPU(s) 1102. Memory 1110, or alternately the non-volatile memory device(s) within memory 1110, comprises a non-transitory computer readable storage medium. In some embodiments, memory 1110 or the computer readable storage medium of memory 1110 stores the following programs, modules and data structures, or a subset thereof:
an operating system 1112 that includes procedures for handling various basic system services and for performing hardware dependent tasks;
a communication module 1114 that is used for connecting financial institution server 114 to other computers via the one or more communication interfaces 1104 (wired or wireless) and one or more communication networks, such as the Internet, other wide area networks, local area networks, metropolitan area networks, and so on;
an optional user interface module 1116 that receives commands from the user via the input devices 1108 and generates user interface objects in the display device 1106;
a transaction processing module 1118 that processes (e.g., authorizes and/or settles) financial transactions between users and merchants that involve non-cash payment instruments.

In some embodiments, the programs or modules identified above correspond to sets of instructions for performing a function described above. The sets of instructions can be executed by one or more processors (e.g., the CPUs 1102). The above identified modules or programs (i.e., sets of instructions) need not be implemented as separate software programs, procedures or modules, and thus various subsets of these programs or modules may be combined or otherwise re-arranged in various embodiments. In some embodiments, memory 1110 stores a subset of the modules and data structures identified above. Furthermore, memory 1110 may store additional modules and data structures not described above.

Although FIG. 11 shows a “financial institution server,” FIG. 11 is intended more as functional description of the various features which may be present in a set of financial transaction servers than as a structural schematic of the embodiments described herein. In practice, and as recognized by those of ordinary skill in the art, items shown separately could be combined and some items could be separated. For example, some items shown separately in FIG. 11 could be implemented on single servers and single items could be implemented by one or more servers. The actual number of servers used to implement a financial institution server and how features are allocated among them will vary from one implementation to another, and may depend in part on the amount of data traffic that the system must handle during peak usage periods as well as during average usage periods.

### Providing Incentives to Users for Using Payment Instruments

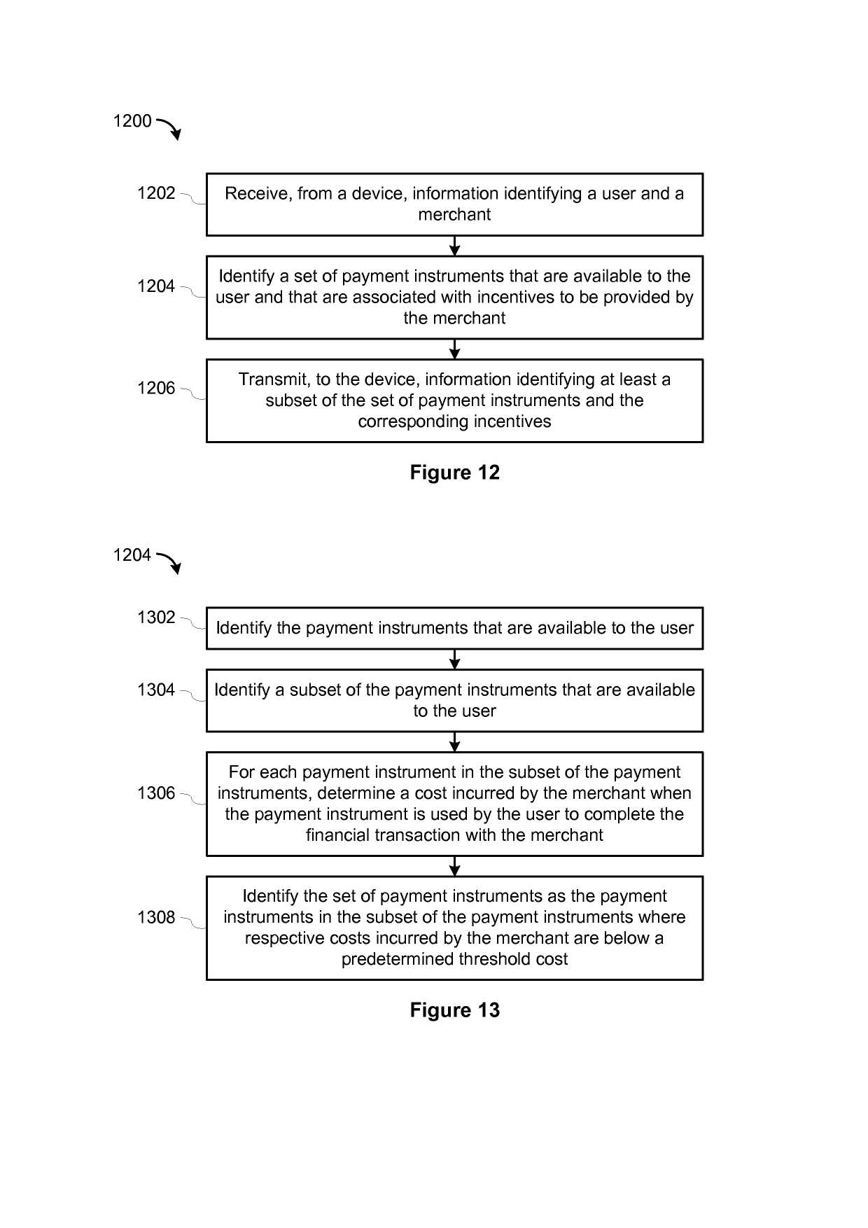

The following discussion refers to the user 106, the merchant 104, and device 110. However, it should be noted that the following discussion may be applied to any user, any merchant, and device. Furthermore, the following discussion refers to particular modules of server 102 performing particular operations. However, the operations discussed below may be performed by other modules. Moreover, the processes discussed below with reference to FIGS. 12-17 correspond to the processes discussed above with reference to FIGS. 4A and 4B.

FIG. 12 is a flowchart of a method 1200 for providing incentives to users for using payment instruments to complete financial transactions, according to some embodiments. Method 1200 is typically performed by server 102. The payment instrument module 404 receives (1202), from device 110, information identifying the user 106 and the merchant 104.

Server 102 (e.g., payment instrument module 404 of server 102) identifies (1204) a set of payment instruments that are available to the user 106 and that are associated with incentives to be provided by the merchant 104. In some embodiments, a respective payment instrument in the set of the payment instruments is associated with at least one incentive to be provided by the merchant when the user uses the respective payment instrument to fulfill a financial transaction with the merchant. For example, the payment instrument module 404 may identify the set of payment instruments for a particular user to include a standard credit card, a rewards credit card, a debit card, a personal check, and cash. Continuing with the example, the standard credit card is associated with an incentive that gives the user 106 a 2.0% discount off of an amount of the financial transaction, the rewards credit card is associated with an incentive that gives the user 106 a 0.1% discount off of an amount of the financial transaction (or alternatively is not associated with any incentive, as it has the highest merchant fees of all the payment instruments in the identified set of payment instruments (see 1202)), the debit card is associated with an incentive that gives the user 106 a 3.0% discount off of an amount of the financial transaction, the personal check is associated with an incentive that gives the user 106 a 3.5% discount off of an amount of the financial transaction, and cash payment is associated with an incentive that gives the user 106 a 5.0% discount off of an amount of the financial transaction. Operation 1204 is described in more detail below with reference to FIG. 13.

Server 102 (e.g., with the assistance of payment instrument module 404 of server 102) transmits (1206), to device 110, information identifying at least a subset of the set of payment instruments and the corresponding incentives. For example, server 102 may transmit the name of the payment instruments and a description of the incentives associated with the payment instruments.

FIG. 13 is a flowchart of a method for identifying (1204) the set of payment instruments that are available to the user 106 and that are associated with incentives to be provided by the merchant 104, according to some embodiments. Server 102 (e.g., payment instrument module 404 of server 102) identifies (1302) the payment instruments that are available to the user 106. For example, the payment instrument module 404 may identify the set of payment instruments that are available to the user 106 to include a standard credit card, a rewards credit card, a charge card, a store charge card issued by another merchant, the debit card, the personal check, and cash.

Server 102 (e.g., payment instrument module 404 of server 102) identifies (1304) a subset of the payment instruments that are available to the user 106, where a respective payment instrument in the subset of the payment instruments is associated with at least one incentive to be provided by the merchant 104 when the respective payment instrument is used by the user 106 to complete a financial transaction with the merchant 104. Continuing the example described with reference to operation 1302, the payment instrument module 404 identifies that the subset of the payment instruments includes the user's standard credit card, debit card, personal check, and cash, but not the rewards credit card and store charge card issued by another merchant. In other implementations, and in other examples or circumstances, a different subset of the payment instruments is identified.

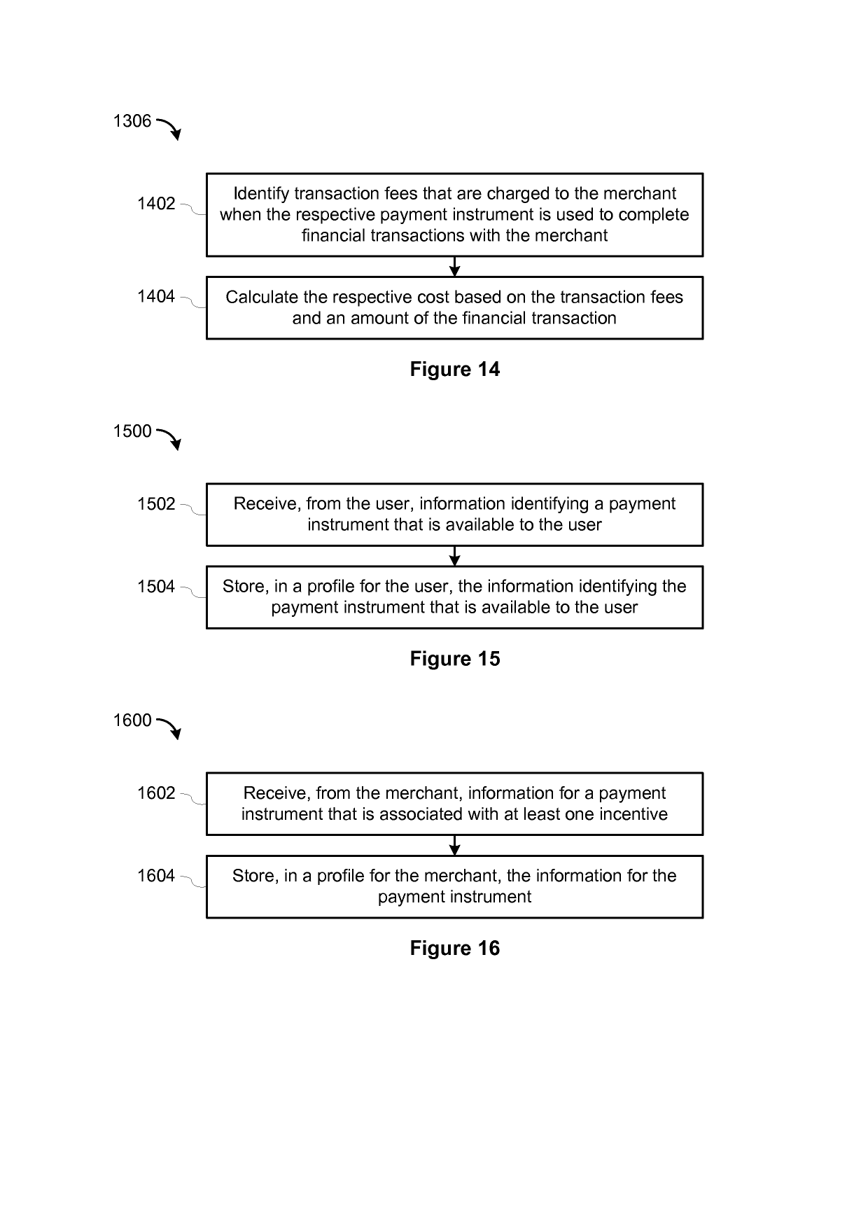

For each payment instrument in the subset of the payment instruments, server 102 (e.g., payment instrument module 404 of server 102) determines (1306) a cost that would be incurred by the merchant 104 if that payment instrument were used by the user 106 to complete the financial transaction with the merchant 104. For example, the payment instrument module 404 may determine that the merchant incurs a 2% transaction fee when the merchant 104 accepts the standard credit card, the merchant incurs a 3% transaction fee when the merchant 104 accepts the rewards card, the merchant incurs a $0.20+0.25% transaction fee when the merchant 104 accepts the debit card, and that the merchant 104 does not incur any transaction fees when the merchant 104 accepts the personal check or cash. Note that when a transaction amount for a financial transaction between the user 106 and the merchant 104 is available, the cost may be expressed as an amount of currency (e.g., dollars) instead of a percentage. Operation 1306 is described in more detail below with reference to FIG. 14.

Server 102 (e.g., payment instrument module 404 of server 102) then identifies (1308) the set of payment instruments as the payment instruments in the subset of the payment instruments where respective costs incurred by the merchant 104, when respective payment instruments in the subset of the payment instruments are used by the user 106 to complete the financial transaction with the merchant 104, are below a predetermined threshold cost. For example, assuming that the predetermined threshold cost is 2%, the payment instrument module 404 identifies the set of payment instruments as the standard credit card, the debit card, the personal check, and cash. When a transaction amount for the financial transaction between the user 106 and the merchant 104 is available, the predetermined threshold cost may be expressed as an amount of currency (e.g., dollars) instead of a percentage.

FIG. 14 is a flowchart of a method for determining (1306) a cost incurred by a merchant when a respective payment instrument is used by a user to complete a financial transaction with the merchant, according to some embodiments. In some implementations, the method of FIG. 14 is used to determine the cost of prospective transactions, which is the cost that would be incurred by a merchant if the user were to use a respective payment instrument to complete a financial transaction with the merchant, as well as the cost of actual transactions. Server 102 (e.g., payment instrument module 404 of server 102) identifies (1402) transaction fees (e.g., a discount rate, a per-transaction fee, or a combination of such fees) that are charged to the merchant when the respective payment instrument is used to complete financial transactions with the merchant 104 and calculates (1404) the respective cost based on the transaction fees and an amount of the financial transaction.

FIG. 15 is a flowchart of a method 1500 for storing information identifying a payment instrument that is available to the user 106, according to some embodiments. The method 1500 is typically performed prior to operation 1202 (FIG. 12). The registration module 406 receives (1502), from the user 106, information identifying a payment instrument that is available to the user 106. The registration module 406 then stores (1504), in a profile for the user 106, the information identifying the payment instrument that is available to the user 106. For example, the registration module 406 may store the information identifying the payment instrument that is available to the user 106 in the user database 408 using the data structure 300. As discussed above, a profile of a user may be generated from information obtained from at least one record of the user database 408.

FIG. 16 is a flowchart of a method 1600 for storing information for a payment instrument accepted by the merchant 104, according to some embodiments. The method 1600 is typically performed prior to operation 1202 (FIG. 12). The registration module 406 receives (1602), from the merchant 104, information for a payment instrument that is associated with at least one incentive. In some embodiments, the information for the payment instrument includes information identifying the payment instrument, and at least one of a cost incurred by the merchant 104 when a respective user uses the payment instrument to fulfill a financial transaction with the merchant 104, and an incentive to be provided to the respective user when the respective user uses the respective payment instrument to fulfill the financial transaction with the merchant 104. The registration module 406 then stores (1604), in a profile for the merchant 104, the information for the payment instrument. For example, the registration module 406 may store the information for the payment instrument in merchant database 410 using the data structure 200. As discussed above, a profile of a merchant may be generated from information obtained from at least one record of merchant database 410.

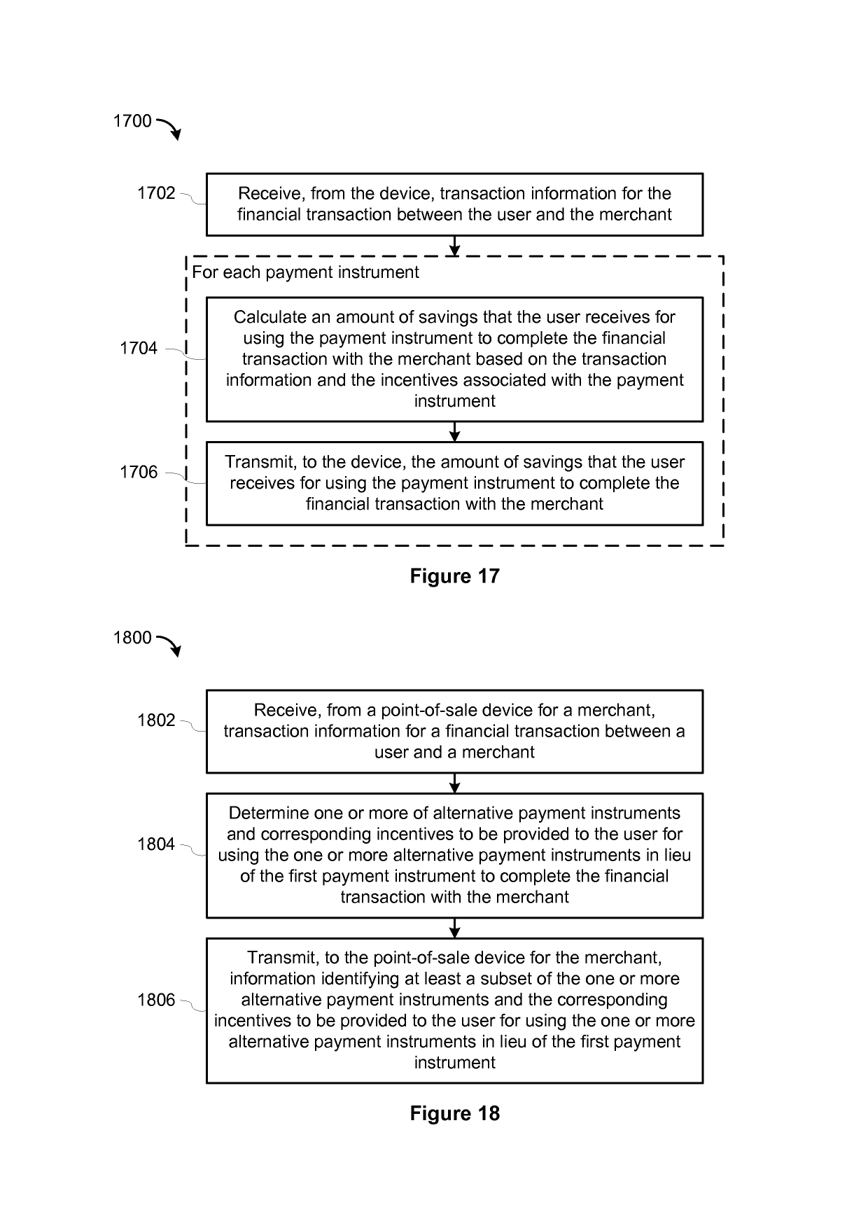

FIG. 17 is a flowchart of a method 1700 for communicating an amount of savings that the user 106 receives for using a payment instrument to complete a financial transaction with the merchant 104, according to some embodiments. Server 102 (e.g., payment instrument module 404 of server 102) receives (1702), from device 110, transaction information for the financial transaction between the user 106 and the merchant 104.

For each payment instrument in the set of payment instruments, server 102 (e.g., payment instrument module 404 of server 102) calculates (1704) an amount of savings that the user 106 receives for using the payment instrument to complete the financial transaction with the merchant 104 based on the transaction information and the incentives associated with the payment instrument. Server 102 then transmits (1706), to device 110, the amount of savings that the user 106 receives (i.e., would receive) for using the payment instrument to complete the financial transaction with the merchant 104.

### Providing Incentives to Users for Using Alternative Payment Instruments

The following discussion refers to the user 106 and the merchant 104. However, it should be noted that the following discussion may be applied to any user and any merchant. Furthermore, the following discussion refers to particular modules of server 102 performing particular operations. However, the operations discussed below may be performed by other modules. Moreover, the processes discussed below with reference to FIGS. 18-23 correspond to the processes discussed above with reference to FIGS. 5A and 5B.

FIG. 18 is a flowchart of a method 1800 for providing incentives to users for using alternative payment instruments to complete financial transactions, according to some embodiments. Server 102 (e.g., payment instrument module 404 of server 102) receives (1802), from a point-of-sale device for the merchant 104 (e.g., device 110), transaction information for a financial transaction between the user 106 and the merchant 104. In some embodiments, the transaction information includes information for a first payment instrument to be used by the user 106 to complete the financial transaction with the merchant 104 and an amount of the financial transaction. For example, the first payment instrument may be a rewards credit card for the user 106 that the user swiped in the point-of-sale device for the merchant 104. In some implementations, the first payment instruments is whatever payment instrument the user first offers to use to complete the financial transaction with the merchant 104. In some other implementations, the first payment instruments is the highest cost payment instrument available to the user for completing the financial transaction with the merchant 104.

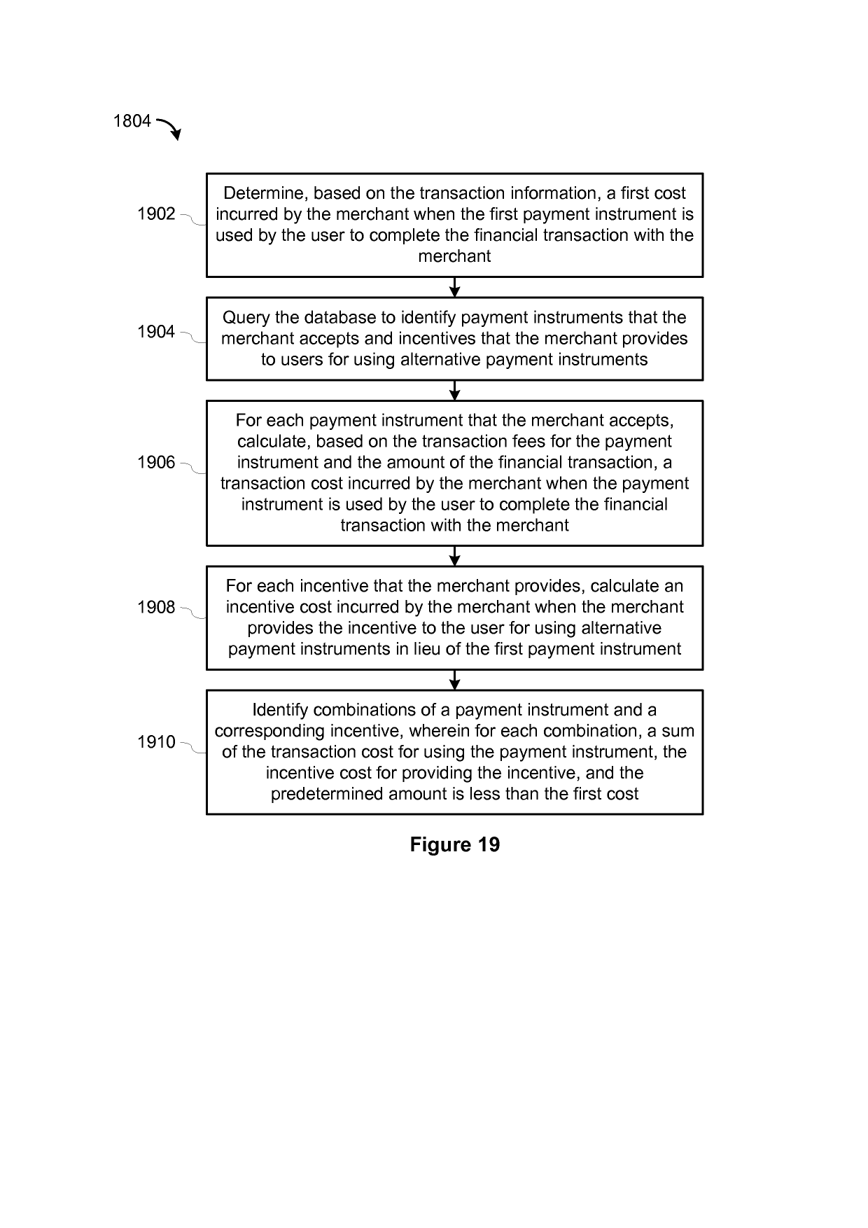

Server 102 (e.g., payment instrument module 404 of server 102) determines (1804) one or more of alternative payment instruments and corresponding incentives to be provided to the user 106 for using the one or more alternative payment instruments in lieu of the first payment instrument to complete the financial transaction with the merchant 104. For example, the payment instrument module 404 may determine that the alternative payment instruments include a standard credit card, a debit card, a personal check, and cash. Operation 1804 is described in more detail with reference to FIG. 19.

Server 102 transmits (1806), to the point-of-sale device for the merchant 104, information identifying at least a subset of the one or more alternative payment instruments and the corresponding incentives to be provided to the user 106 for using the one or more alternative payment instruments in lieu of the first payment instrument.

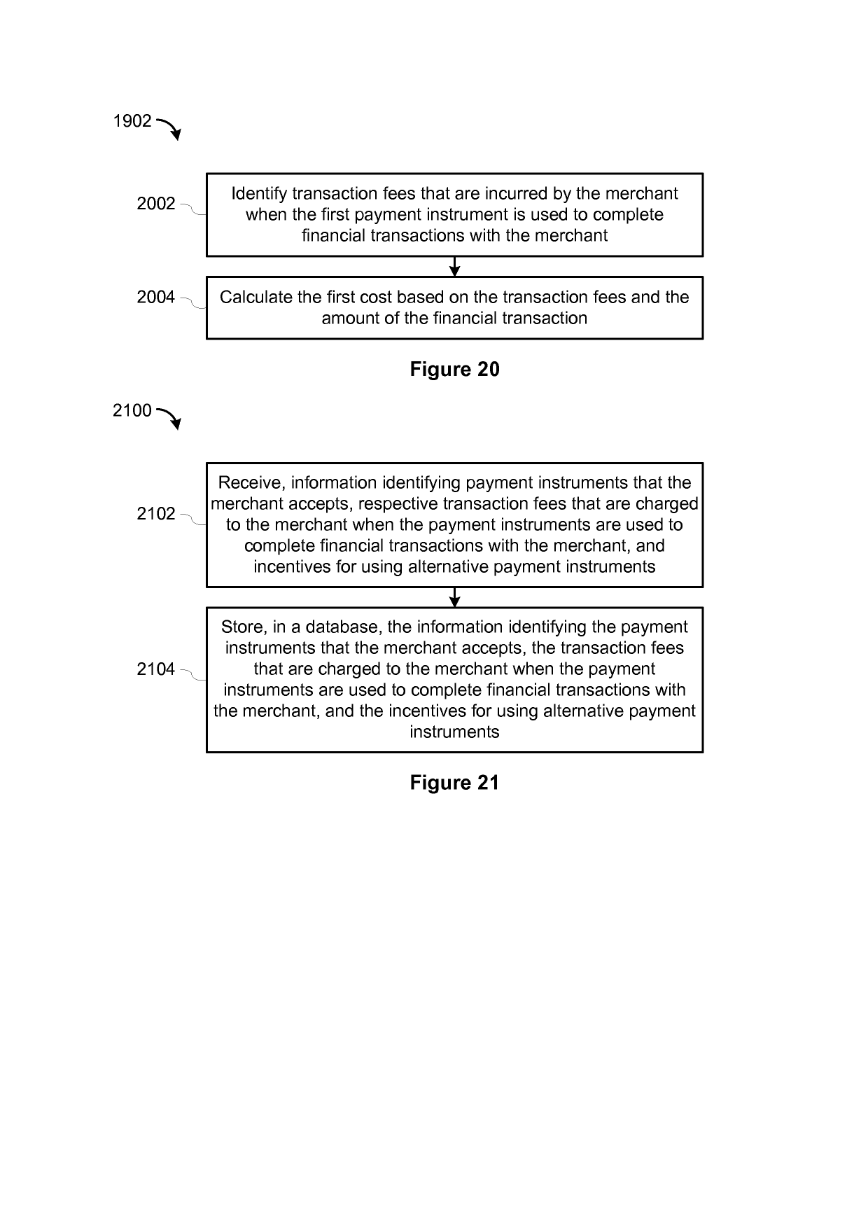

FIG. 19 is a flowchart of a method for determining (1804) one or more alternative payment instruments and corresponding incentives to be provided to the user 106 for using the one or more alternative payment instruments in lieu of the first payment instrument to complete the financial transaction with the merchant 104, according to some embodiments. Server 102 (e.g., payment instrument module 404 of server 102) determines (1902), based on the transaction information, a first cost incurred by the merchant 104 when the first payment instrument is used by the user 106 to complete the financial transaction with the merchant 104. For example, the payment instrument module 404 may determine that the merchant incurs 3.5% in transaction fees (e.g., a discount rate, a per-transaction fee, or a combination of a per-transaction fee and a discount rate) when the merchant 104 accepts the rewards card. Note that the first cost may be expressed as an amount of currency (e.g., dollars) instead of a percentage. Operation 1902 is described in more detail below with reference to FIG. 20.

Server 102 (e.g., payment instrument module 404 of server 102) queries (1904) a database (e.g., merchant database 410) to identify payment instruments that the merchant 104 accepts and incentives that the merchant 104 provides to users for using alternative payment instruments. For example, the payment instrument module 404 may determine that the alternative payment instruments include the standard credit card, the debit card, the personal check, and cash. Furthermore, the payment instrument module 404 may determine that the merchant 104 offers the following incentives: 0.5%, 1%, 1.5% and 2% discounts off of an amount of the financial transaction. Note that the incentive may be expressed as an amount of currency (e.g., dollars) instead of a percentage.

For each payment instrument that the merchant 104 accepts, the payment instrument module 404 calculates (1906), based on the transaction fees for the payment instrument and the amount of the financial transaction, a transaction cost incurred by the merchant 104 when the payment instrument is used by the user 106 to complete the financial transaction with the merchant 104. For example, the payment instrument module 404 may determine that the merchant incurs 1% in transaction fees (i.e., the transaction cost) when the merchant 104 accepts the standard credit card, the merchant incurs 0.5% in transaction fees when the merchant 104 accepts the debit card, and that the merchant 104 does not incur any transaction fees when the merchant 104 accepts the personal check or cash. Note that the transaction fees may be expressed as an amount of currency (e.g., dollars) instead of a percentage.

For each incentive that the merchant 104 provides, the payment instrument module 404 calculates (1908) an incentive cost incurred by the merchant 104 when the merchant 104 provides the incentive to the user 106 for using alternative payment instruments in lieu of the first payment instrument.

Server 102 (e.g., payment instrument module 404 of server 102) identifies (1910) combinations of a payment instrument and a corresponding incentive, wherein for each combination, a sum of the transaction cost for using the payment instrument, the incentive cost for providing the incentive, and the predetermined amount is less than the first cost. For example, assuming that the predetermined amount is 0.5%, the payment instrument module 404 may determine that the standard credit card is associated with an incentive that gives the user 106 a 1.5% (e.g., 1%+1.5%+0.5%=3%<3.5%) discount off of an amount of the financial transaction, the debit card is associated with an incentive that gives the user 106 a 2% (e.g., 0.5%+2%+0.5%=3%<3.5%) discount off of an amount of the financial transaction, the personal check is associated with an incentive that gives the user 106 a 2% (e.g., 0%+2%+0.5%=2.5%<3.5%) discount off of an amount of the financial transaction, and the cash is associated with an incentive that gives the user 106 a 2% (e.g., 0%+2%+0.5%=2.5%<3.5%) discount off of an amount of the financial transaction.

In some embodiments, the identified combinations of payment instruments and corresponding incentives (in operation 1910) only include payment instruments that are available to the user 106.

FIG. 20 is a flowchart of a method for determining (1902) the first cost incurred by the merchant 104 when the first payment instrument is used by the user 106 to complete the financial transaction with the merchant 104, according to some embodiments. As noted above, the calculated first cost is a prospective cost that would be incurred by the merchant 104 if the user 106 in fact were to complete the financial transaction using the first payment instrument. Server 102 (e.g., payment instrument module 404 of server 102) identifies (2002) transaction fees that are incurred by the merchant 104 when the first payment instrument is used to complete financial transactions with the merchant 104 and calculates (2004) the first cost based on the transaction fees and the amount of the financial transaction.

FIG. 21 is a flowchart of a method 2100 for storing information for a payment instrument accepted by the merchant 104, according to some embodiments. Server 102 (e.g., payment instrument module 404 of server 102) receives (2102), information identifying payment instruments that the merchant 104 accepts, respective transaction fees that are charged to the merchant 104 when the payment instruments are used to complete financial transactions with the merchant 104, and incentives for using alternative payment instruments. Server 102 (e.g., payment instrument module 404 of server 102) then stores (2104), in a database (e.g., merchant database 410), the information identifying the payment instruments that the merchant 104 accepts, the transaction fees that are charged to the merchant 104 when the payment instruments are used to complete financial transactions with the merchant 104, and the incentives for using alternative payment instruments.

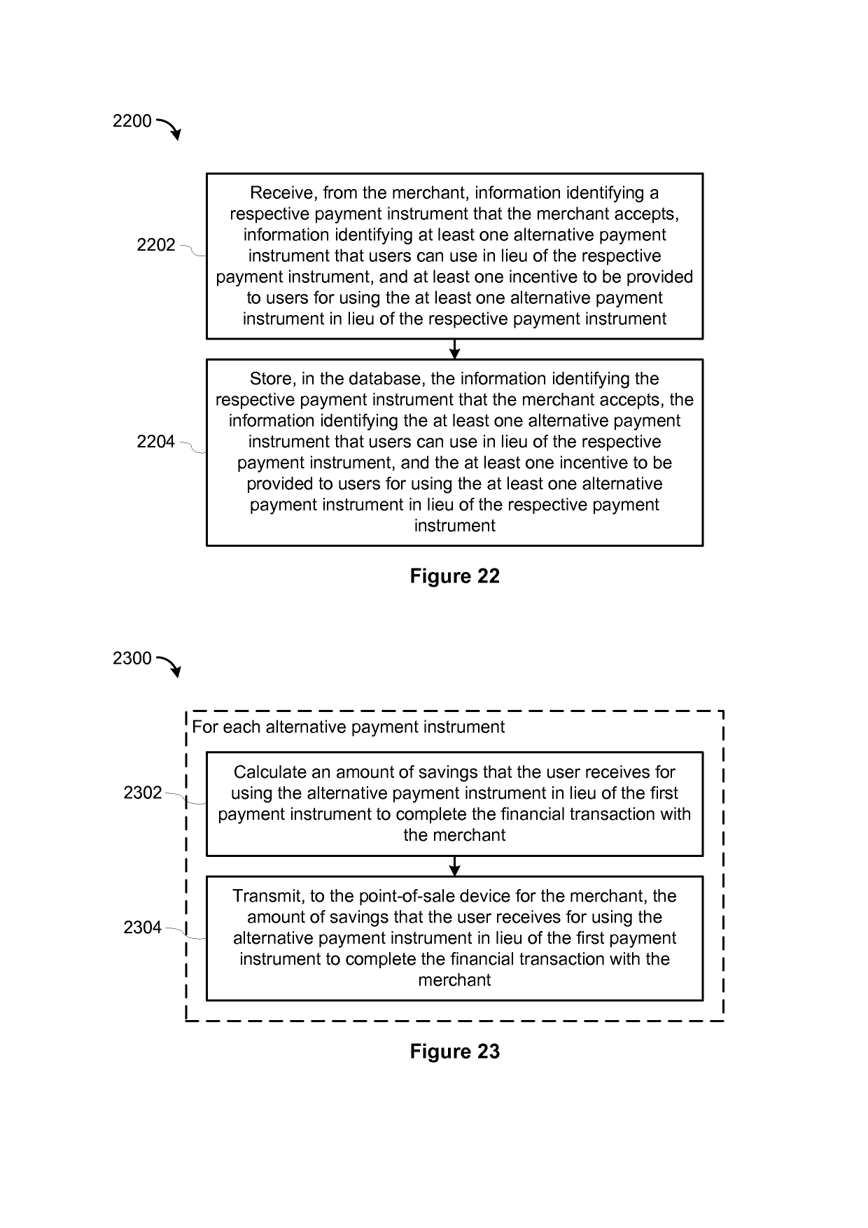

FIG. 22 is a flowchart of a method 2200 for storing information for a payment instrument accepted by the merchant 104, according to some embodiments. Method 2200 is an alternative to method 2100. Server 102 (e.g., payment instrument module 404 of server 102) receives (2202), from the merchant 104, information identifying a respective payment instrument that the merchant 104 accepts, information identifying at least one alternative payment instrument that users can use in lieu of the respective payment instrument, and at least one incentive to be provided to users for using the at least one alternative payment instrument in lieu of the respective payment instrument. Server 102 (e.g., payment instrument module 404 of server 102) then stores (2204), in the database (e.g., merchant database 410), the information identifying the respective payment instrument that the merchant 104 accepts, the information identifying the at least one alternative payment instrument that users can use in lieu of the respective payment instrument, and the at least one incentive to be provided to users for using the at least one alternative payment instrument in lieu of the respective payment instrument.

In some embodiments, when determining (1804) the one or more alternative payment instruments and the corresponding incentives to be provided to the user for using the alternative payment instruments in lieu of the first payment instrument to complete the financial transaction with the merchant 104, server 102 (e.g., payment instrument module 404 of server 102) queries the database (e.g., merchant database 410) to identify the one or more alternative payment instruments that the user 106 can use in lieu of the first payment instrument to complete the financial transaction with the merchant 104 and the corresponding incentives to be provided to the user 106 for using the alternative payment instruments in lieu of the first payment instrument to complete the financial transaction with the merchant 104.

FIG. 23 is a flowchart of a method 2300 for communicating an amount of savings that the user 106 receives for using an alternative payment instrument to complete a financial transaction with the merchant 104, according to some embodiments. Optionally, method 2300 is used to implement operations 1804 and 1806 of method 1800. For each respective alternative payment instrument in a set of one or more alternative payment instruments (e.g., the subset discussed above with respect to operation 1806), server 102 (e.g., payment instrument module 404 of server 102) calculates (2302) an amount of savings that the user 106 receives for using the alternative payment instrument in lieu of the first payment instrument to complete the financial transaction with the merchant 104 and transmits (2304), to the point-of-sale device for the merchant 104, the amount of savings that the user 106 receives for using the alternative payment instrument in lieu of the first payment instrument to complete the financial transaction with the merchant. Note that the amount of savings is a function of the incentives. In the example discussed above, if the user 104 uses the standard credit card instead of the rewards credit card, the amount of savings is 1.5% of the transaction amount of the financial transaction.

The methods illustrated in FIGS. 12-23 are typically governed by instructions that are stored in a computer readable storage medium and that are executed by at least one processor of at least one server (e.g., server 102). Each of the operations shown in FIGS. 12-23 correspond to instructions stored in a non-transitory computer memory or non-transitory computer readable storage medium. In various implementations, the non-transitory computer readable storage medium includes a magnetic or optical disk storage device, solid state storage devices such as Flash memory, or other non-volatile memory device or devices. The computer readable instructions stored on the non-transitory computer readable storage medium are typically in source code, assembly language code, object code, or other instruction format that is interpreted and/or executable by one or more processors.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

It will also be understood that, although the terms “first,” “second,” etc. may be used herein to describe various elements, these elements should not be limited by these terms. These terms are only used to distinguish one element from another. For example, a first contact could be termed a second contact, and, similarly, a second contact could be termed a first contact, which changing the meaning of the description, so long as all occurrences of the “first contact” are renamed consistently and all occurrences of the second contact are renamed consistently. The first contact and the second contact are both contacts, but they are not the same contact.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative implementations. For purposes of explanation, numerous specific details were set forth in order to provide an understanding of various implementations of the inventive subject matter. It will be evident, however, to those skilled in the art that implementations of the inventive subject matter may be practiced without these specific details.

What is claimed is:

1. A computer-implemented method for providing incentives to users for using payment instruments to complete financial transactions, performed on a server having at least one processor and memory storing at least one program for execution by the at least one processor to perform the method, comprising:
receiving, from a device, information identifying a user and a merchant;
identifying a set of payment instruments that are available to the user and that are associated with incentives to be provided by the merchant, a respective payment instrument in the set of the payment instruments being associated with at least one incentive to be provided by the merchant when the user uses the respective payment instrument to fulfill a financial transaction with the merchant; and
transmitting, to the device, information identifying at least a subset of the set of payment instruments and the corresponding incentives.

2. The computer-implemented method of claim 1, wherein prior to receiving the information identifying the user and the merchant, the method includes:
receiving, from the user, information identifying a payment instrument that is available to the user; and
storing, in a profile for the user, the information identifying the payment instrument that is available to the user.

3. The computer-implemented method of claim 1, wherein prior to receiving the information identifying the user and the merchant, the method includes:
receiving, from the merchant, information for a payment instrument that is associated with at least one incentive, wherein the information for the payment instrument includes information identifying the payment instrument, and information selected from the group consisting of: a cost incurred by the merchant when a respective user uses the payment instrument to fulfill a financial transaction with the merchant, and the at least one incentive to be provided to the respective user when the respective user uses the respective payment instrument to fulfill the financial transaction with the merchant; and
storing, in a profile for the merchant, the information for the payment instrument.

4. The computer-implemented method of claim 3, wherein the cost incurred by the merchant when the respective user uses the respective payment instrument to fulfill the financial transaction with the merchant is selected from the group consisting of:
a discount rate associated with the payment instrument; and
a per-transaction fee associated with the payment instrument.

5. The computer-implemented method claim 1, wherein identifying the set of payment instruments that are available to the user and that are associated with incentives to be provided by the merchant includes:
identifying the payment instruments that are available to the user;
identifying a subset of the payment instruments that are available to the user, wherein a respective payment instrument in the subset of the payment instruments is associated with at least one incentive to be provided by the merchant when the respective payment instrument is used by the user to complete the financial transaction with the merchant;
for each payment instrument in the subset of the payment instruments, determining a cost incurred by the merchant when the payment instrument is used by the user to complete the financial transaction with the merchant; and
identifying the set of payment instruments as the payment instruments in the subset of the payment instruments where respective costs incurred by the merchant, when respective payment instruments in the subset of the payment instruments are used by the user to complete the financial transaction with the merchant, are below a predetermined threshold cost.

6. The computer-implemented method of claim 5, wherein determining the cost incurred by the merchant when a respective payment instrument is used by the user to complete the financial transaction with the merchant includes:
identifying transaction fees that are charged to the merchant when the respective payment instrument is used to complete financial transactions with the merchant; and
calculating the respective cost based on the transaction fees and an amount of the financial transaction.

7. The computer-implemented method of claim 1, further comprising:
receiving, from the device, transaction information for the financial transaction between the user and the merchant; and
for each payment instrument in the set of payment instruments,
calculating an amount of savings that the user receives for using the payment instrument to complete the financial transaction with the merchant based on the transaction information and the incentives associated with the payment instrument; and
transmitting, to the device, the amount of savings that the user receives for using the payment instrument to complete the financial transaction with the merchant.

8. The computer-implemented method of claim 1, wherein the device is a point-of-sale device for the merchant.

9. The computer-implemented method of claim 8, wherein the information identifying the user includes information obtained from a credit card of the user.

10. The computer-implemented method of claim 1, wherein the information identifying the merchant includes information obtained from a merchant account associated with the point-of-sale device for the merchant.

11. The computer-implemented method of claim 1, wherein the device is a mobile electronic device for the user.

12. The computer-implemented method of claim 11, wherein the information identifying the user includes information obtained from the mobile device of the user.

13. The computer-implemented method of claim 1, wherein the information identifying the merchant includes information obtained from a barcode.

14. The computer-implemented method of claim 13, wherein a respective incentive is selected from the group consisting of:
a predetermined discount off of an amount of the financial transaction;
a redeemable rebate having a predetermined value;
a predetermined discount off of a price for a product;
a predetermined discount off of a cost for a service;
a free product;
a free service;
a gift card having a predetermined value; and
a coupon having a predetermined value.

15. A system to provide incentives to users for using payment instruments to complete financial transactions, comprising:
at least one processor;
memory; and
at least one program stored in the memory and executable by the at least one processor, the at least one program comprising instructions to:
receive, from a device, information identifying a user and a merchant;
identify a set of payment instruments that are available to the user and that are associated with incentives to be provided by the merchant, a respective payment instrument in the set of the payment instruments being associated with at least one incentive to be provided by the merchant when the user uses the respective payment instrument to fulfill a financial transaction with the merchant; and
transmit, to the device, information identifying at least a subset of the set of payment instruments and the corresponding incentives.

16. The system of claim 15, wherein prior to receiving the information identifying the user and the merchant, the at least one program includes instructions to:
receive, from the user, information identifying a payment instrument that is available to the user; and
store, in a profile for the user, the information identifying the payment instrument that is available to the user.

17. The system of claim 15, wherein prior to receiving the information identifying the user and the merchant, the at least one program includes instructions to:
receive, from the merchant, information for a payment instrument that is associated with at least one incentive, wherein the information for the payment instrument includes information identifying the payment instrument, and information selected from the group consisting of: a cost incurred by the merchant when a respective user uses the payment instrument to fulfill a financial transaction with the merchant, and the at least one incentive to be provided to the respective user when the respective user uses the respective payment instrument to fulfill the financial transaction with the merchant; and
store, in a profile for the merchant, the information for the payment instrument.

18. The system of claim 17, wherein the cost incurred by the merchant when the respective user uses the respective payment instrument to fulfill the financial transaction with the merchant is selected from the group consisting of:
a discount rate associated with the payment instrument; and
a per-transaction fee associated with the payment instrument.

19. The system of claim 15, wherein the instructions to identify the set of payment instruments that are available to the user and that are associated with incentives to be provided by the merchant include instructions to:
identify the payment instruments that are available to the user;
identify a subset of the payment instruments that are available to the user, wherein a respective payment instrument in the subset of the payment instruments is associated with at least one incentive to be provided by the merchant when the respective payment instrument is used by the user to complete the financial transaction with the merchant;
for each payment instrument in the subset of the payment instruments, determine a cost incurred by the merchant when the payment instrument is used by the user to complete the financial transaction with the merchant; and
identify the set of payment instruments as the payment instruments in the subset of the payment instruments where respective costs incurred by the merchant, when respective payment instruments in the subset of the payment instruments are used by the user to complete the financial transaction with the merchant, are below a predetermined threshold cost.

20. The system of claim 19, wherein the instructions to determine the cost incurred by the merchant when a respective payment instrument is used by the user to complete the financial transaction with the merchant include instructions to:
identify transaction fees that are charged to the merchant when the respective payment instrument is used to complete financial transactions with the merchant; and
calculate the respective cost based on the transaction fees and an amount of the financial transaction.

21. A non-transitory computer readable storage medium storing at least one program configured for execution by at least one processor of a computer system, the at least one program comprising instructions to:
receive, from a device, information identifying a user and a merchant;
identify a set of payment instruments that are available to the user and that are associated with incentives to be provided by the merchant, a respective payment instrument in the set of the payment instruments being associated with at least one incentive to be provided by the merchant when the user uses the respective payment instrument to fulfill a financial transaction with the merchant; and
transmit, to the device, information identifying at least a subset of the set of payment instruments and the corresponding incentives.

22. The non-transitory computer readable storage medium of claim 21, wherein prior to receiving the information identifying the user and the merchant, the at least one program includes instructions to:
receive, from the user, information identifying a payment instrument that is available to the user; and
store, in a profile for the user, the information identifying the payment instrument that is available to the user.

23. A system to provide incentives to users for using alternative payment instruments to complete financial transactions, comprising:
at least one processor;
memory; and
at least one program stored in the memory and executable by the at least one processor, the at least one program comprising instructions to:
receive, from a point-of-sale device for a merchant, transaction information for a financial transaction between a user and a merchant, the transaction information including information for a first payment instrument to be used by the user to complete the financial transaction with the merchant and an amount of the financial transaction;
determine one or more of alternative payment instruments and corresponding incentives to be provided to the user for using the one or more alternative payment instruments in lieu of the first payment instrument to complete the financial transaction with the merchant; and
transmit, to the point-of-sale device for the merchant, information identifying at least a subset of the one or more alternative payment instruments and the corresponding incentives to be provided to the user for using the one or more alternative payment instruments in lieu of the first payment instrument.

24. The system of claim 23, wherein the at least one program includes instructions to:
receive, prior to receiving the transaction information for the financial transaction between the user and the merchant, information identifying payment instruments that the merchant accepts, respective transaction fees that are charged to the merchant when the payment instruments are used to complete financial transactions with the merchant, and incentives for using alternative payment instruments; and
store, in a database, the information identifying the payment instruments that the merchant accepts, the transaction fees that are charged to the merchant when the payment instruments are used to complete financial transactions with the merchant, and the incentives for using alternative payment instruments.

25. The system of claim 24, wherein the instructions to determine the one or more alternative payment instruments and corresponding incentives to be provided to the user for using the one or more alternative payment instruments in lieu of the first payment instrument to complete the financial transaction with the merchant include instructions to:
determine, based on the transaction information, a first cost incurred by the merchant when the first payment instrument is used by the user to complete the financial transaction with the merchant;
query the database to identify payment instruments that the merchant accepts and incentives that the merchant provides to users for using alternative payment instruments;
for each payment instrument that the merchant accepts, calculate, based on the transaction fees for the payment instrument and the amount of the financial transaction, a transaction fee incurred by the merchant when the payment instrument is used by the user to complete the financial transaction with the merchant;
for each incentive that the merchant provides, calculate an incentive cost incurred by the merchant when the merchant provides the incentive to the user for using alternative payment instruments in lieu of the first payment instrument; and
identify combinations of a payment instrument and a corresponding incentive, wherein for each combination, a sum of the transaction fee for using the payment instrument, the incentive cost for providing the incentive, and the predetermined amount is less than the first cost.

26. The system of claim 25, wherein the instructions to determine the first cost incurred by the merchant when the first payment instrument is used by the user to complete the financial transaction with the merchant include instructions to:
identify transaction fees that are incurred by the merchant when the first payment instrument is used to complete financial transactions with the merchant; and
calculate the first cost based on the transaction fees and the amount of the financial transaction.
